(19) United States
(12) Patent Application Publication
(10) Pub. No.: US 2004/0213152 A1
(43) Pub. Date: Oct. 28, 2004

(54) Packet-relaying device

(76) Inventors: Makoto Matuoka, Iizuka (JP); Mikio Shimazu, Kasuya-Gun (JP); Michinori Kishimoto, Iizuka (JP); Seiji Kubo, Iizuka (JP)

Correspondence Address: WENDEROTH, LIND & PONACK, L.L.P., 2033 K STREET N. W., SUITE 800, WASHINGTON, DC, 20006-1021, US

(21) Appl. No.: 10/797,141

(22) Filed: Mar. 11, 2004

(30) Foreign Application Priority Data
Mar. 12, 2003 (JP) 2003-066454

(51) Int. Cl. H04L 12/56

(52) U.S. Cl. 370/230

(57) ABSTRACT

Every entry of a flow table has the following fields: a source IP address; a destination IP address; a protocol number; an identification; a source port number; a destination port number; a payload type; and SSRC information. An RTP-judging unit judges, when IP packets having a characteristic of a RTP header have been inputted continuously for predetermined time, that each of the IP packets includes an RTP packet. A packet-classifying unit classifies an inputted IP packet according to a judgment result by the RTP-judging unit and a pre-defined packet-classifying-rule.

### BACKGROUND OF THE INVENTION

1. Field of the Invention

The present invention relates to a packet-relaying device. More particularly, it relates to a technique that controls a plurality of packets according to the priority thereof.

2. Description of the Related Art

In an IP (Internet Protocol) network, packets with high priority and packets with low priority flow altogether. In a “best effort” mode, when the IP network is crowded, resources necessary for communications cannot be obtained. Therefore, not only packets with low priority but also packets with high priority are discarded at random.

In order to avoid such a situation, a QoS (Quality of Service) control technique is noteworthy. Related arts will now be explained using some examples of priority control of packets that flow in a network provided in a company. In this network, it is assumed that web packets used by a post “A” of the company should be transmitted as packets with high priority, and further that the other packets should be transmitted as packets with low priority.

(First Conventional Technique)

With the first conventional technique, each router of this network inputs a packet to be transmitted. And, each router of this network checks whether or not the inputted packet belongs to the web packets used by the post A. When the inputted packet belongs to the web packets, each router of this network transmits the packet preferentially.

It is judged whether or not the packet has high priority, referring to the followings: a destination IP address; a source IP address; a protocol number; a destination port number; and a source port number. Herein, the destination IP address, the source IP address, and the protocol number are included in an IP header of an IP packet. The destination port number and the source port number are included in a TCP/UDP header, which continues after the IP header.

In “layer 2” switches, whether or not the packet has high priority may be judged by referring priority of a frame with a VLAN tag.

The priority processes using the priority of the frame with the VLAN tag are stated in various references (See, for example, “LAN switching Tettei Kaisetsu”, written by Rich Seifert work, translated into Japanese by Akira Mamiya, Nikkei Business Publications, 2001, Chapter 13).

(Second Conventional Technique)

The second conventional technique uses a Diffserv (Differentiated Services) method.

This method is defined by the IETF (Internet Engineering Task Force), which is a standardization organization of the Internet techniques.

In the Diffserv method, a ToS (Type of Service) field, which is composed of 8 bits in the IP header, is redefined as a DS (Differentiated Services) field. Packets are transmitted according to a value of a DSCP (Differentiated Services Code Point), which is set in 6 bits of the DS field.

Redefinition of the DS field is stated in RFC2474 (See “Definition of the Differentiated Services Field (DS Field) in the IPv4 and IPv6 Headers”, RFC2474, December 1998).

Packet-transmitting methods according to the DSCP are stated in RFC2475 (See “An Architecture for Differentiated Services”, RFC2475, December 1998).

Using the Diffserv method, the above-mentioned example is processed as follows.

A router that marks a DSCP on a DS field of a packet, checks whether or not the packet belongs to web packets of the post “A”. When the packet belongs to the web packets, the router marks high priority to the DSCP of the packet, and otherwise the router marks low priority to a DSCP of the packet.

A router that does not mark a DSCP performs priority control of the packet, according to the DSCP, which may be marked by other router to the packet.

Also in this case, similar to the first conventional technique, the router that marks the DSCP judges whether or not the packet belongs to web packets of the post “A”, referring to the followings: a destination IP address; a source IP address; a protocol number; a destination port number; and a source port number.

In both first and second conventional techniques, routers are, in many cases, established by administrators managing the network.

Recently, the Internet is always accessed using a broadband router. Even in an ordinary home, the broadband router is provided, and plural terminals access the Internet via the router simultaneously.

Furthermore, not only e-mail services and web services but also AV (Audio/Visual) application services, such as video data delivery services and interactive communication services, are spreading.

Since products that have a network-connecting function and a moving pictures-storing function, such as DVD (Digital Video Disc) decks, have begun to appear in the market, also at an ordinary home, moving pictures, which are stored in some medium existing somewhere, are transmitted via a network constructed in the home and further are reproduced. Herein, the broadband router plays a central role in the network.

The AV application services should be performed in real time, because, when the network is so crowded that packets for the AV application services are discarded or delayed, the services are influenced seriously and cannot be used practically.

Therefore, it seemed that an ordinary home-oriented broadband router, which is one of packet-relaying devices, may implement a QoS control function.

The IETF defines an RTP (Real-time Transport Protocol) and RTCP (RTP Control Protocol). The RTP is a protocol used when packets of AV data, which relate to an image/picture or a voice, are transmitted.

In general, the RTP is used as a higher-level protocol of the UDP. When a time stamp and/or a sequence number are/is attached to a UDP header, synchronization of reproducing can be realized.

The RTCP is used as a control protocol for feeding back the attached information to a source terminal.

The RTP and RTCP are stated in RFC1889 (See “RTP: A TranspoRTProtocol for Real-Time Applications”, RFC1889, January 1996).

When a packet is transmitted and further the packet passes through a network whose MTU (Maximum Transfer Unit) is smaller than the size of the packet, the packet is fragmented into two or more pieces. In this specification, each of the pieces is called a fragmented packet.

When fragmentation of the packet occurs, the original packet is divided into a head packet (head fragmented packet) and one or more packets (non-head fragmented packet(s)) positioned after the head packet.

The head fragmented packet has an IP header of the original packet and a TCP/UDP header of the original packet. Each of the one or more non-head fragmented packets has the IP header of the original packet. However, each of the one or more non-head fragmented packets loses the TCP/UDP header of the original packet.

In the first and second conventional techniques, in order to judge whether or not a packet has high priority, a port number of the TCP/UDP header is referred.

Therefore, whether or not a non-head fragmented packet has high priority cannot be judged.

Generally, each of packets with unknown priority is processed as a packet with low priority.

When the original packet has high priority and further the original packet is fragmented, the one or more non-head fragmented packets divided from the original packet, which should have high priority originally, may be processed with low priority.

Furthermore, in the first and second conventional techniques, there are the following problems concerning priority control of RTP packets.

The RTP is used for transmitting packets generated by an AV application, and is a UDP type protocol generally.

Since RTP packets relate to an AV application, which should be performed in real time, the RTP packets must be processed with high priority.

Since RFC1889 has determined that the RTP uses even port numbers, the first and second conventional techniques, each of which judges priority of packets using the port number of the TCP/UDP header, cannot be applied.

The RTCP is a control protocol of the RTP.

It is considerable that packets of the RTCP should be processed with high priority.

Herein, a port number of an RTCP packet is an odd number next to the even port number of the RTP packet. However, while the even port number of the RTP packet is unknown, the port number of the RTCP packet cannot be determined. It is not clear which RTCP packet within a plurality of RTCP packets does relate to a specific RTP packet.

In many cases, it is very difficult for a user at an ordinary home to set the packet-relaying device such that the packet-relaying device processes preferentially to a specific kind of IP packets, like an administrator of a company does.

Countermeasures against both fragmentation and RTP problems must be realized including the priority control using two or more queues.

### OBJECTS AND SUMMARY OF THE INVENTION

In view of the above, an object of the present invention is to provide a packet-relaying device that can perform priority control of packets more precisely than the conventional techniques.

To be more specific, the object of the present invention is to provide a technique that can identify and control packets that should be performed with high priority originally, even when fragmentation of the packets occurs, and further that can solve the problems of the RTP and/or RTCP packets.

Furthermore, the present invention provides simple user interface and makes it easy to set classification rule of IP packets.

A first aspect of the present invention provides a packet-relaying device, comprising: a plurality of queues, each of the plurality of queues being operable to store a packet in correspondence to priority thereof; scheduler operable to take out a packet from one of the plurality of queues to output the packet to the outside; a packet-classifying-rule-storing unit operable to store a packet-classifying rule; a packet-classifying unit operable to output a packet to one of said plurality of queues based on the packet-classifying rule stored in the packet-classifying-rule-storing unit; and a flow information-storing unit operable to store flow-defining information of a flow and priority information of the flow, wherein the flow information-storing unit is operated in a manner different from that of the packet-classifying-rule-storing unit.

With this structure, since the flow information-storing unit is operated in a manner different from that of the packet-classifying-rule-storing unit, priority control of packets can be performed more accurately than a case where the priority control of packets is performed according to only the packet-classifying rule. That is, countermeasure against both fragmentation and RTP problems can be realized more easily than the prior arts.

A second aspect of the present invention provides a packet-relaying device as defined in the first aspect of the present invention, wherein the flow-defining information includes, a source IP address of an IP header, a destination IP address of the IP header, a protocol number of the IP header, and an identification of the IP header.

With this structure, since the flow-defining information includes the identification, when fragmentation arises, fragmented packets can be handled as those belonging to the same flow based on the identification of the flow-defining information of the flow information-storing unit.

A third aspect of the present invention provides a packet-relaying device as defined in the first aspect of the present invention, the packet-relaying device further comprising a header-checking unit operable to check whether or not an inputted packet is a non-head fragmented packet.

With this structure, since a head fragmented packet and a non-head fragmented packet can be clearly distinguished using the header-checking unit, the head fragmented packet and the non-head fragmented packet can be processed in corresponding manners.

A fourth aspect of the present invention provides a packet-relaying device as defined in the third aspect of the present invention, wherein the header-checking unit is operable to judge whether or not the inputted packet is a head fragmented packet, and wherein the packet-relaying device further comprises a flow information-registering unit operable to register, into the flow information-storing unit, flow-defining information of a flow to which the inputted packet belongs and priority information of the flow when the header-checking unit judges that the inputted packet is a head fragmented packet.

With this structure, when a head fragmented packet reaches to the packet-relaying device, information of a head fragmented packet, especially information that a non-head fragmented packet loses, can be added into flow information. Therefore, one or more non-head fragmented packets after the head fragment packet can be handled as if each of one or more non-head fragmented packets did not lose a TCP/UDP header, and priority control of each of one or more non-head fragmented packets can be performed.

A fifth aspect of the present invention provides a packet-relaying device as defined in the third aspect of the present invention, the packet-relaying device further comprising a flow-determining unit operable to output a packet that is judged to be a non-head fragmented packet by the header-checking unit to one of the plurality of queues, based on the flow-defining information and the priority information stored in the flow information-storing unit, wherein the packet-classifying unit outputs a packet that is judged to be not a non-head fragmented packet by the header-checking unit to one of the plurality of queues, based on the packet-classifying rule stored in the packet-classifying-rule-storing unit.

With this structure, priority control of the non-head fragmented packet is performed by the flow-determining unit using the flow information, and priority control of the packet that is not a non-head fragmented packet is performed by the packet-classifying unit using the packet-classifying-rule. Therefore, priority control according to characteristics of these packets can be performed, respectively.

A sixth aspect of the present invention provides a packet-relaying device as defined in the fifth aspect of the present invention, wherein the flow-determining unit judges whether a non-head fragmented packet is a final non-head fragmented packet, and wherein the packet-relaying device further comprising a first deleting unit operable to delete flow-defining information of a flow to which the final non-head fragmented packet belongs and priority information of the flow from the flow information-storing unit.

With this structure, since, when the final non-head fragmented packet reaches to the packet-relaying device, flow information thereof is deleted from the flow information of the flow information-storing unit, a waste of system resources can be avoided. Furthermore, since volume of the flow information is reduced, processes can be performed more rapidly.

A seventh aspect of the present invention provides a packet-relaying device as defined in the first aspect of the present invention, the packet-relaying device further comprising a second deleting unit operable to delete flow-defining information of a flow that any packet belonging to the flow is not inputted for predetermined time and priority information of the flow from the flow information-storing unit.

With this structure, under a simple condition, that is, with the passage of predetermined time, flow information being not used is deleted from the flow information of the flow information-storing unit, a waste of system resources can be avoided. Furthermore, since volume of the flow information is reduced, processes can be performed more rapidly.

An eighth aspect of the present invention provides a packet-relaying device as defined in the first aspect of the present invention, the packet-relaying device further comprising a flow-determining unit operable to output a packet to one of the plurality of queues based on flow-defining information and priority information stored in the flow information-storing unit when the flow-defining information of a flow of the packet and the priority information of the flow are registered in the flow information-storing unit, wherein the packet-classifying unit outputs the packet to one of the plurality of queues based on packet-classifying rule stored in the packet-classifying-rule-storing unit when the flow-defining information of a flow of the packet and the priority information of the flow are not registered in the flow information-storing unit.

With this structure, processes giving priority to control using the flow information over control using the packet-classifying rule can be realized.

A ninth aspect of the present invention provides a packet-relaying device as defined in the eighth aspect of the present invention, the packet-relaying device further comprising an RTP-judging unit operable to judge whether or not the packet is an RTP packet.

With this structure, an inputted packet can be judged whether or not it is an RTP packet.

A tenth aspect of the present invention provides a packet-relaying device as defined in the ninth aspect of the present invention, wherein, when the packet has a UDP header and a port number of the UDP header is an even number that is “1024” or more, the RTP-judging unit judges that the packet is an RTP packet, according to at least one of a version field after the UDP header and a payload type field of an RTP payload, the version field indicating an RTP protocol version.

With this structure, whether or not the inputted packet is an RTP packet can be judged precisely using small amount of information.

An eleventh aspect of the present invention provides a packet-relaying device as defined in the ninth aspect of the present invention, the packet-relaying device further comprising a flow information-registering unit operable to register, when the RTP-judging unit judges that the packet is an RTP packet, flow-defining information of a flow of the packet and priority information of the flow into the flow information-storing unit.

With this structure, judgment result showing whether or not the inputted packet is an RTP packet can be reflected to the flow information.

For example, priority control that the inputted packet is processed with high priority when the inputted packet is an RTP packet can be performed.

A twelfth second aspect of the present invention provides a packet-relaying device as defined in the ninth aspect of the present invention, wherein the flow-defining information includes a port number of a TCP/UDP header, and wherein, when the RTP-judging unit judges that the packet is an RTP packet, the flow-determining unit outputs the packet to one of the plurality of queues, based on information that a value of “1” is added to a port number of a TCP/UDP header of flow-defining information relating to the packet and priority information of an RTCP packet.

With this structure, when an RTP packet is found, the same priority control as the RTP packet can be performed to the RTCP packet corresponding to the RTP packet.

A thirteenth aspect of the present invention provides a packet-relaying device as defined in the ninth aspect of the present invention, wherein the flow-defining information includes a port number of a TCP/UDP header, and wherein, when the RTP-judging unit judges that the packet is an RTP packet, the flow information-registering unit registers information that a value of “1” is added to a port number of a TCP/UDP header of flow-defining information relating to the packet and priority information of the packet into the flow information-storing unit.

With this structure, once the above information is registered to the flow information-storing unit, the same priority control as the RTP packet can be performed to the RTCP packet corresponding to the RTP packet continuously.

A fourteenth aspect of the present invention provides a packet-relaying device as defined in the ninth aspect of the present invention, the packet-relaying device further comprising a header-checking unit operable to judge if an inputted packet is a non-head fragmented packet, wherein the flow-determining unit inputs the inputted packet from the header-checking unit.

With this structure, since judging whether or not the inputted packet is a non-head fragment packet is performed prior to determining a flow to which the inputted packet relates, priority control according flow information can be performed correctly.

A fifteenth aspect of the present invention provides a packet-relaying device as defined in the first aspect of the present invention, the packet-relaying device further comprising an AV packet-judging unit operable to judge whether or not an inputted packet is an AV packet, wherein the packet-classifying unit outputs the packet to one of the plurality of queues such that an AV packet has higher priority than a non AV packet.

With this structure, since AV packets are handled with the higher priority, probability that AV data composed of plural AV packets are processed in real time increases.

A sixteenth aspect of the present invention provides a packet-relaying device as defined in the fifteenth aspect of the present invention, wherein, when the inputted packet is an HTTP packet, the AV packet-judging unit judges whether or not the inputted packet is an AV packet according to information of Context-Type of the inputted packet.

With this structure, whether or not the inputted packet is an HTTP packet can be judged precisely using small amount of information.

A seventeenth aspect of the present invention provides a packet-relaying device as defined in the fifteenth aspect of the present invention, wherein, when a packet of a flow defined in the flow information-storing unit has been inputted continuously for predetermined time, the AV packet-judging unit judges that the flow defined in the flow information-storing unit is a flow of an AV packet.

With this structure, whether or not the inputted packet is an AV packet is judged paying attention to time continuity of AV packets.

An eighteenth aspect of the present invention provides a packet-relaying device as defined in the fifteenth aspect of the present invention, wherein the AV packet-judging unit judges whether or not a flow defined in the flow information-storing unit is related to an AV packet, by comparing a number of inputted packets of the flow with a predetermined AV threshold.

With this structure, by a simple criterion, that is, a comparison between the number of the flow information-storing unit and the predetermined AV threshold, whether or not the inputted packet is an AV packet can be judged rapidly and precisely.

A nineteenth aspect of the present invention provides a packet-relaying device as defined in the fifteenth aspect of the present invention, wherein the flow information-storing unit stores information of an AV threshold concerning a flow defined therein, and wherein the AV packet-judging unit judges whether or not the packet is an AV packet using the AV threshold that is stored in the flow information storing unit and that is set based on packet size such that the AV threshold is greater for a video packet than for an audio packet.

With this structure, since the AV threshold for a video packet is greater than the AV threshold for an audio packet, an AV packet is judged precisely according a type of AV packets.

A twentieth aspect of the present invention provides a packet-relaying device as defined in the nineteenth aspect of the present invention, the packet-relaying device further comprising an item-deleting unit operable to delete information of a flow from the flow information-storing unit when an inputted packet defined in the flow information-storing unit has packet size different from the packet size stored in the flow information-storing unit.

With this structure, by a simple comparison of packet size, information being not used is deleted from the flow information of the flow information-storing unit, and a waste of system resources can be avoided. Furthermore, since volume of the flow information is reduced, processes can be performed more rapidly.

A twenty-first aspect of the present invention provides a packet-relaying device as defined in the first aspect of the present invention, the packet-relaying device further comprising an RTP-judging unit operable to judge whether or not an inputted packet is an RTP packet, wherein the RTP-judging unit judges that a flow defined in the flow information-storing unit is a flow of an RTP packet when a packet of the flow defined in the flow information-storing unit has been inputted continuously for predetermined time.

With this structure, an RTP packet can be controlled with high priority. Furthermore, whether or not the inputted packet is an RTP packet is judged paying attention to time continuity of RTP packets.

A twenty-second aspect of the present invention provides a packet-relaying device as defined in the first aspect of the present invention, the packet-relaying device further comprising: a switch operable to be used for changing a packet-classifying-rule stored in the packet-classifying-rule-storing unit; and a packet-classifying-rule-changing unit operable to change the packet-classifying rule stored in the packet-classifying-rule-storing unit according to a state of the switch.

With this structure, a user of the packet-relaying device can change the packet-classifying rule easily using the switch.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of a packet-relaying device in an embodiment of the present invention;

FIG. 2 is a block diagram of an outputting interface in an embodiment 1 of the present invention;

FIG. 3 is a descriptive illustration, showing how packets in the embodiment 1 of the present invention flow;

FIG. 4 is a descriptive illustration, showing classification rules in the embodiment 1 of the present invention;

FIG. 5(a) to FIG. 5(c) are descriptive illustrations, each showing a status of a flow table in the embodiment 1 of the present invention;

FIG. 6 is a flow chart, showing packet-classifying processes in the embodiment 1 of the present invention;

FIG. 7 is a flow chart, showing entry-deleting processes of a flow table in the embodiment 1 of the present invention;

FIG. 8 is a block diagram of an outputting interface in an embodiment 2 of the present invention;

FIG. 9 is a flow chart, showing packet-classifying processes in the embodiment 2 of the present invention;

FIG. 10 is a flow chart, showing RTP-judging processes in the embodiment 2 of the present invention;

FIG. 11 is a block diagram of an outputting interface in an embodiment 3 of the present invention;

FIG. 12 is a descriptive illustration, showing how packets in the embodiment 3 of the present invention flow;

FIG. 13(a) and FIG. 13(b) are descriptive illustrations, each showing a status of a flow table in the embodiment 3 of the present invention;

FIG. 14 is a flow chart, showing packet-classifying processes in the embodiment 3 of the present invention;

FIG. 15 is a block diagram of an outputting interface in the embodiment 3 of the present invention;

FIG. 16(a) to FIG. 16(g) are descriptive illustrations, each showing a status of a flow table in an embodiment 4 of the present invention;

FIG. 17 is a flow chart, showing packet-classifying processes in the embodiment 4 of the present invention;

FIG. 18 is a flow chart, showing AV packet-judging processes in the embodiment 4 of the present invention;

FIG. 19 is a block diagram of an outputting interface in an embodiment 5 of the present invention;

FIG. 20(a) to FIG. 20(d) are descriptive illustrations, each showing a status of a flow table in the embodiment 5 of the present invention;

FIG. 21 is a flow chart, showing packet-classifying processes in the embodiment 5 of the present invention;

FIG. 22(a) is a descriptive illustration, showing packet-classifying rules in the embodiment 4 of the present invention;

FIG. 22(b) is a descriptive illustration, showing packet-classifying rules in the embodiment 5 of the present invention;

FIG. 23 is a block diagram of an outputting interface in an embodiment 6 of the present invention;

FIG. 24(a) and FIG. 24(b) are external views of switches in the embodiment 6 of the present invention; and

FIG. 25(a) and FIG. 25(b) are descriptive illustrations, each showing packet-classifying rules in the embodiment 6 of the present invention.

### DETAILED DESCRIPTION OF THE PREFERRED EMBODIMENTS

Referring to the drawings, embodiments of the present invention will now be explained below.

Basic Composition

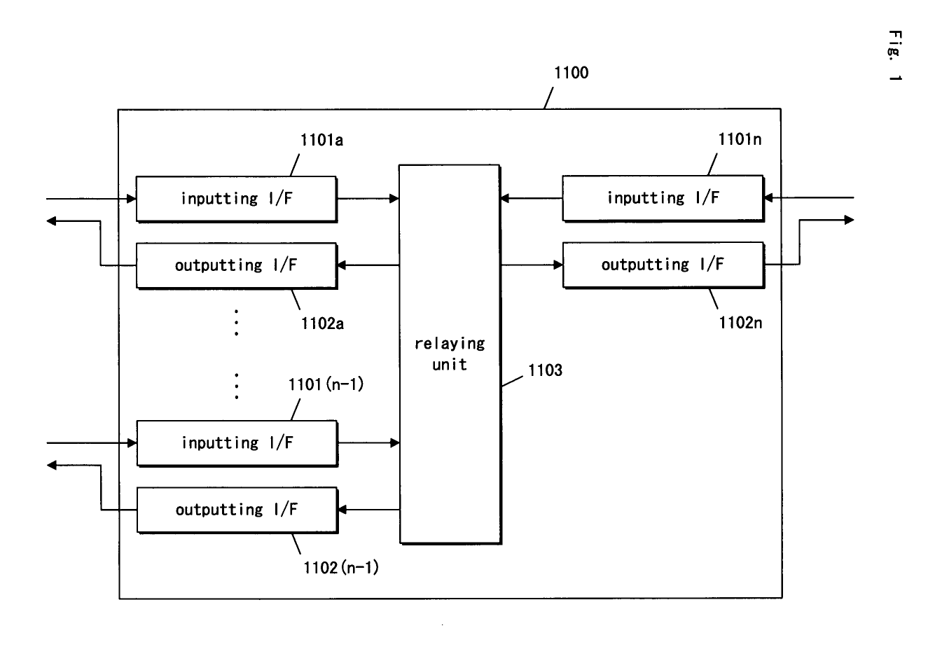

FIG. 1 is a block diagram of a packet-relaying device in an embodiment of the present invention. A packet-relaying device 1100 comprises: two or more inputting interfaces 1101a to 1101n, and two or more outputting interface 1102a to 1102n. Each of the outputting interfaces 1102a to 1102n is connected to a relaying unit 1103.

The present invention relates to a QoS control technique for guaranteeing communication quality of packets transmitted from the packet-relaying device 1100. Hereinafter, it is assumed that the QoS control is performed in the outputting interface 1102n among the outputting interfaces 1102a to 1102n. However, the QoS control may be performed in an arbitrary element among the outputting interfaces 1102a to 1102n and the relaying unit 1103.

In embodiments 1 to 6, the outputting interface 1102n of the present invention will be explained in detail. In these embodiments 1 to 6, it is assumed that priority of a packet belongs to one of two levels, that is, a level of “high priority class” and a level of “low priority class.” A class with the highest priority is a “high priority class”, and a class with the lowest priority is a “low priority class”.

However, the present invention is not limited to a case having two levels of priority, and the present invention can be similarly applied to cases having three or more levels of priority as described below.

In each of the following embodiments 1 to 6, when there is no entry of non-head fragmented packets in a flow table, priority of the non-head fragmented packets is determined to be the lowest. That is, default priority is the lowest. On the contrary, the default priority may be the highest.

### Embodiment 1

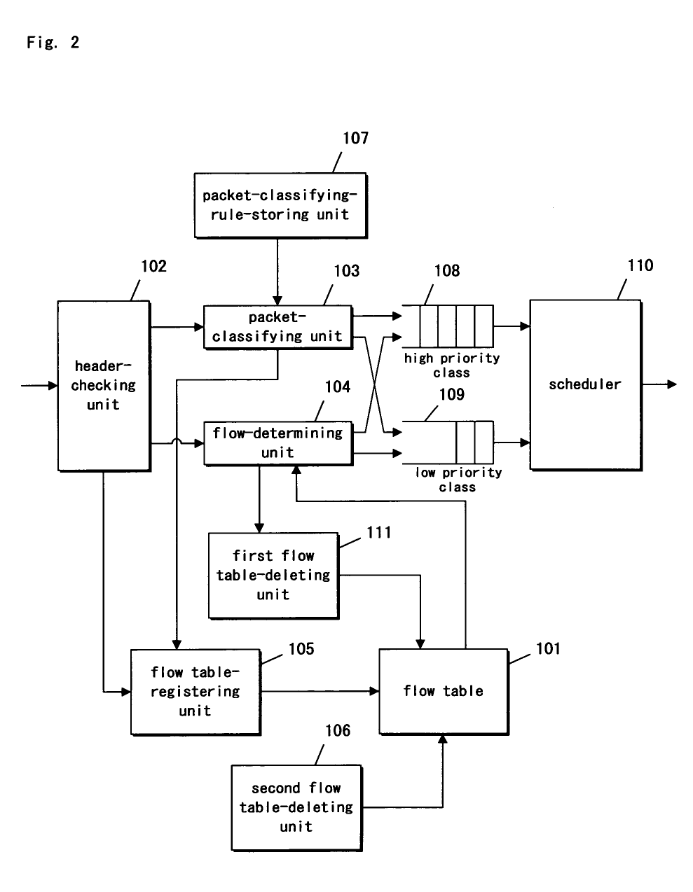

FIG. 2 is a block diagram of an outputting interface 1102n in an embodiment 1 of the present invention. This embodiment corresponds to fragmentation of one or more packets.

As shown in FIG. 2, an outputting interface 1102n comprises the following elements. A queue 108 stores IP packets classified into the high priority class. A queue 109 stores IP packets classified into the low priority class. A plurality of queues, which are as many as the number of priority classes, are prepared. In this embodiment 1, each of the number of priority classes and the number of queues prepared is “2”.

A packet-classifying-rule-storing unit 107 stores the rule defined beforehand, in order to classify IP packets inputted into the outputting interface 1102n, into one of the high priority class and the low priority class.

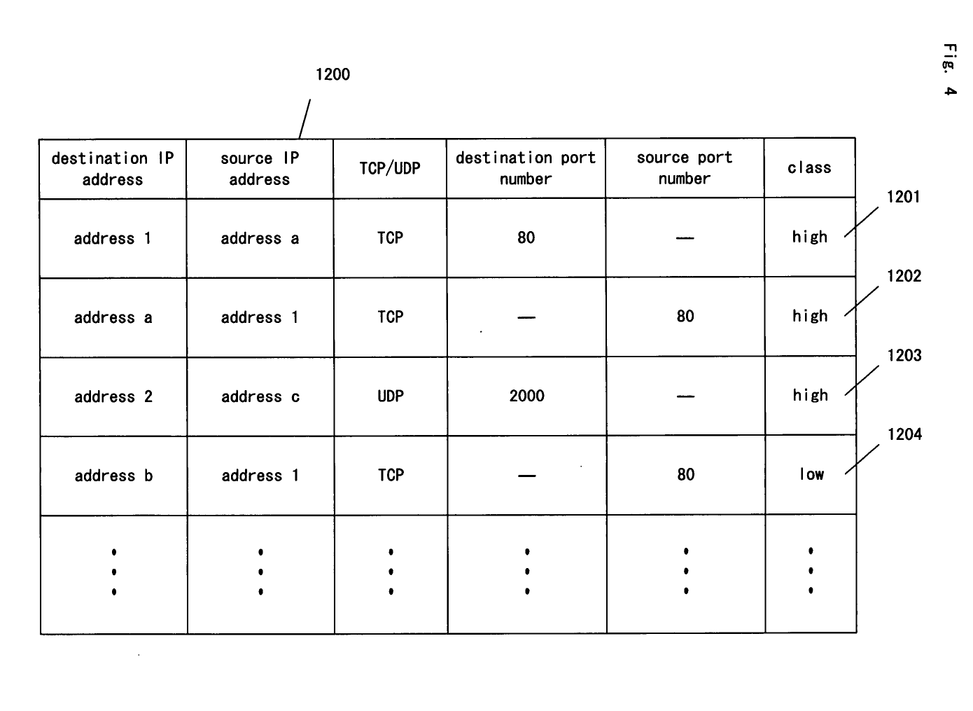

FIG. 4 indicates rules defined in the packet-classifying-rule-storing unit 107. Each of the rules has the following fields: a destination IP address; a source IP address; a flag of TCP/UDP; a destination port number; a source port number; and a class. A value of the class is “high” or “low”, and the class shows priority of an IP packet.

For example, a rule 1201 indicates the followings. That is, the destination IP address is “the address 1”, the source IP address is “Address a”, and the higher-level protocol of IP shows “TCP”. Furthermore, IP packets whose destination port number of TCP is “80” should be classified into the high priority class. A symbol of “-” means “don't care”

In FIG. 2, a scheduler 110 takes a packet from one of the queues 108 and 109 and outputs the taken packet to the outside, according to a certain method, for example, a PQ (Priority Queuing) method. The priority transmittal method in the scheduler 110 can be selected arbitrarily.

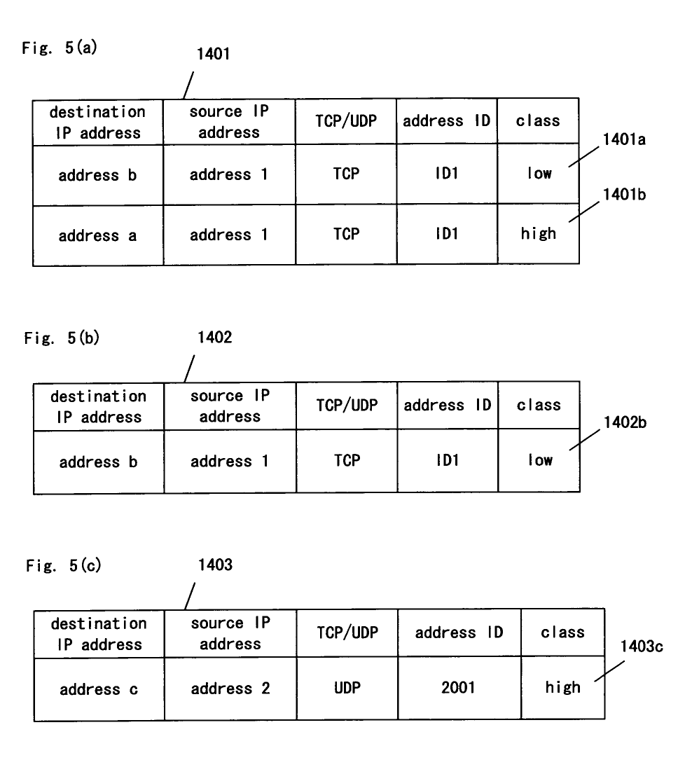

As shown in FIG. 5(a), a flow table 101 has one entry per one flow. Each entry has the following fields: a source IP address; a destination IP address; a flag of TCP/UDP; an identification; and a class. All of values of the fields are included in an IP header of an IP packet. The flow table 101 corresponds to a flow information-storing unit that can store flow-defining information of the flow and priority information of the flow.

In each embodiment of the present invention, a flow information-storing unit is composed of the flow table 101, and information of one flow is recorded in one entry of the flow table 101. Of course, the flow information-storing unit may store information necessary in an arbitrary manner, and any of well-known storage formats, such as a list, may be used as the flow information-storing unit.

In FIG. 2, a header-checking unit 102 judges or not an inputted IP packet is a non-head fragmented packet, whether or not the inputted IP packet is a head fragmented packet, and whether or not the inputted IP packet is a final fragmented packet. Whether or not it is a non-head fragmented packet can be judged using a value of an FO (Fragment Offset) of the IP packet. Whether or not it is a final fragmented packet can be judged using a value of an MF (More Fragment) of the IP packet.

When the inputted IP packet is a non-head fragmented packet, the header-checking unit 102 outputs the inputted IP packet to a flow-determining unit 104. When the inputted IP packet is not a non-head fragmented packet, the header-checking unit 102 outputs the inputted IP packet to the packet-classifying unit 103 and outputs information of the inputted IP packet to a flow table-registering unit 105.

The flow table-registering unit corresponds to a flow information-registering unit that registers flow-defining information of a flow to which an inputted packet belongs and priority information of the flow into the flow table 101 when the header-checking unit 102 judges that the inputted packet is a head fragmented packet.

The packet-classifying unit 103 outputs a packet to one of the queues 108 and 109 according to priority the packet, referring to a packet-classifying-rule-storing unit 107. Herein, the packet is not a non-head fragmented packet, and is inputted from the header-checking unit 102.

The flow-determining unit 104 outputs a packet to one of the queues 108 and 109 according to the priority of the packet, referring to the flow table 101. Herein, the packet is one of a non-head fragmented packet and a non-fragmented packet, and is inputted from the header-checking unit 102.

When a packet corresponds to all values of all fields of a certain entry of the flow table 101, the flow-determining unit 104 determines that the packet belongs to a flow defined using the entry. Otherwise, when a packet does not correspond to at least one value of at least one field of a certain entry of the flow table 101, the flow-determining unit 104 determines that the packet does not belongs to a flow defined using the entry.

When there is no entry to which a packet belongs, the flow-determining unit 104 determines that the priority of the packet is “low”, which is a default priority value and outputs this packet into the queue 109.

When the flow table-registering unit 105 inputs information of a head-fragmented packet, the flow table-registering unit 105 registers a new entry concerning the inputted IP packet into the flow table 101.

When the inputted IP packet is a final fragmented packet, a first flow table-deleting unit 111 deletes an entry concerning this IP packet from the flow table 101.

The first flow table-deleting unit 111 corresponds to a first deleting unit. When the flow-determining unit 104 judges that a certain packet is a final non-head fragmented packet, the first deleting unit deletes an entry to which the packet relates from the flow table 101. The entry includes flow-defining information and priority information.

For every predetermined period of time, a second flow table-deleting unit 106 checks elapsed time of each entry of the flow table 101. When there is an entry whose elapsed time is beyond a predetermined threshold, the second flow table-deleting unit 106 deletes the entry from the flow table 101.

The second flow table-deleting unit 106 corresponds to a second deleting unit that deletes flow-defining information and priority information from the flow table 101, concerning a flow whose elapsed time is beyond a predetermined threshold.

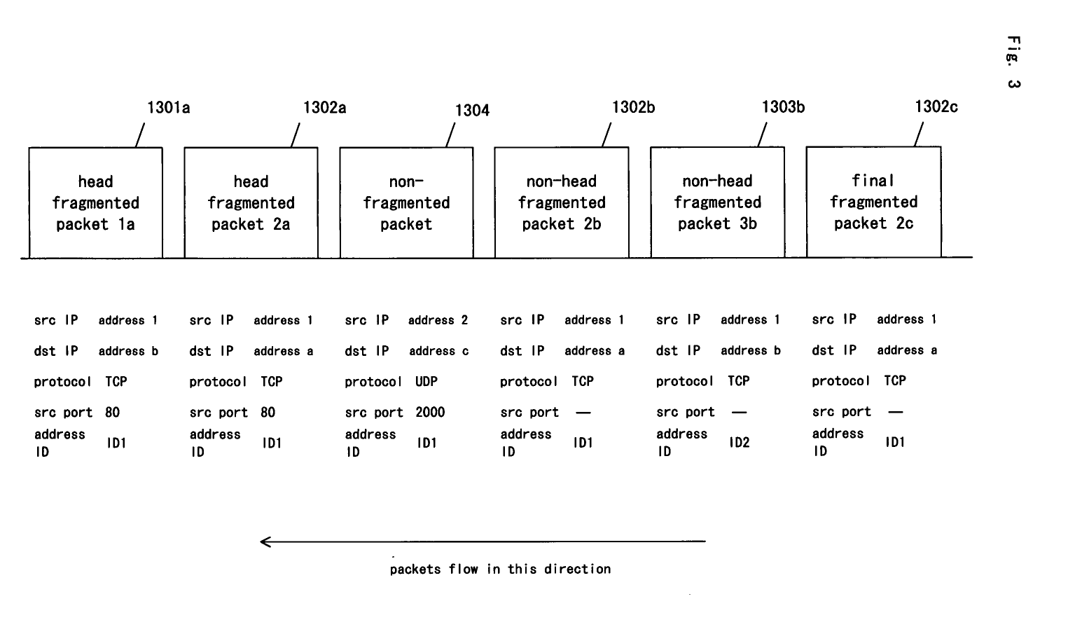

FIG. 3 illustrates a flow of IP packets inputted into the outputting interface 1102n of the packet-relaying device 1100. In FIG. 3, IP packets 1302a, 1302b, and 1302c are fragmented and divided from one IP packet. The IP packet 1302a is a head fragmented packet, the IP packet 1302b is a second (non-head, non-final) fragmented packet, and the IP packet 1302c is a third (non-head , final) fragmented packet.

An IP packet 1301a is a head fragmented packet, and second and subsequent fragmented packets continuing after the IP packet 1301a have not yet reached to the packet-relaying device 1100 in FIG. 3. An IP packet 1304 is a non-fragmented IP packet. An IP packet 1303b is a fragmented IP packet.

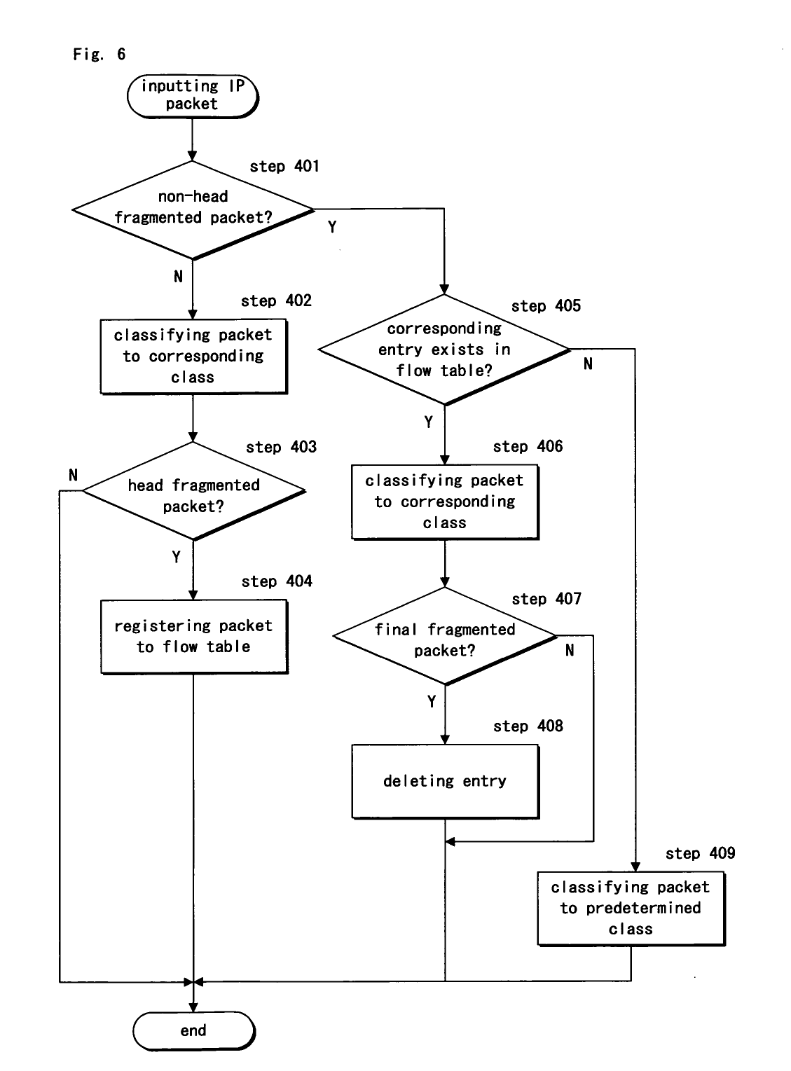

FIG. 6 is a flow chart of the outputting interface 1102n in the embodiment 1 of the present invention.

When an IP packet is inputted into the outputting interface 1102n of the packet-relaying device 1100, the header-checking unit 102 checks whether or not the inputted IP packet is a non-fragmented packet (step 401).

When the inputted IP packet is not a non-head fragmented packet, the header-checking unit 102 outputs the inputted IP packet to the packet-classifying unit 103. Referring to the packet-classifying-rule-storing unit 107, the packet-classifying unit 103 determines a class of the inputted IP packet, and outputs the IP packet to one of the queues 108 and 109 relating to the determined class (step 402).

Next, the packet-classifying unit 103 checks whether or not the inputted IP packet is a head fragmented packet (step 403). When the inputted IP packet is a head fragment packet, the packet-classifying unit 103 makes the flow table-registering unit 105 register a new entry relating to the IP packet to the flow table 101 (step 404).

On the other hand, when the inputted IP packet is a non-head fragmented packet, the flow-determining unit 104 searches the flow table 101 for an entry whose source IP address, destination IP address, protocol number, and identification are all equal to those of the IP header of the inputted IP packet (step 405).

When the entry is found, referring to class information of the entry, the flow-determining unit 104 outputs the IP packet to one of the queues 108 and 109 corresponding to the class information (step 406). When the entry is not found, the flow-determining unit 104 outputs the IP packet into the queue 109 for a low priority class (step 409).

When the entry is found (step 405) and the inputted IP packet is a final non-head fragmented packet (step 407), the first flow table-deleting unit 111 deletes the entry relating to the inputted IP packet from the flow table 101 (step 408).

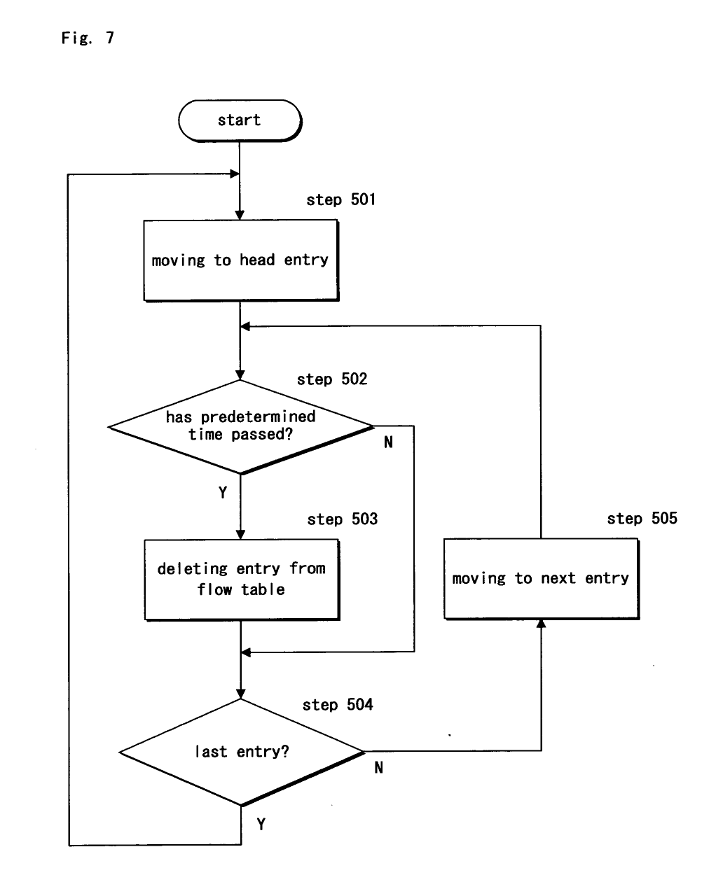

FIG. 7 illustrates how the second flow table-deleting unit deletes an entry from the flow table 101. The second flow table-deleting unit 106 searches an entry that has not been used for predetermined time, sequentially from a head entry of the flow table 101 (steps 501 and 502).

When the entry is found, the second flow table-deleting unit 106 deletes the entry from the flow table 101 (step 503). Otherwise, the second flow table-deleting unit 106 does not do anything.

When a current entry is not the last entry of the flow table 101 (step 504), the current entry is changed to the next entry of the flow table 101 (step 505).

When the current entry is the last entry of the flow table 101 (step 504), the current entry returns to the head entry of the flow table 101, and the second flow table-deleting unit 106 repeats the above-mentioned processes.

Referring now to FIG. 3, FIG. 5, and FIG. 6, an example of operation will be explained. FIG. 5(a) to FIG. 5(c) indicate how the flow table 101 changes.

As shown in FIG. 3, when the IP packets 1301a and 1302a are inputted to the outputting interface 1102n of the packet-relaying device 1100, whether or not each of these IP packets 1301a and 1302a is a non-head fragmented packet is checked (step 401).

The IP packet 1301a corresponds to a rule 1204 in FIG. 4, and the IP packet 1302a corresponds to a rule 1202 in FIG. 4. Therefore, the IP packet 1301a is outputted into the queue 109 for the low priority class, and the IP packet 1302a is outputted into the queue 108 for the high priority class (step 402).

Since these two IP packets 1301a and 1302a are head fragmented packets, respectively (step 403), the entries relating to these two IP packets 1301a and 1302a are registered to the flow table 101 (step 404). At this time, class information thereof is added to each of the entries that have been just registered (steps 1401a and 1401b).

As shown in FIG. 3, when the IP packets 1304 is inputted to the outputting interface 1102n of the packet-relaying device 1100, whether or not the IP packets 1304 is a non-head fragmented packet is checked (step 401). Since the IP packet 1304 corresponds to a rule 1203 of FIG. 4, the IP packets 1304 is outputted into the queue 108 for the high priority class (step 402). Herein, since the IP packet 1304 is not a head fragmented packet (step 403), an entry relating to the IP packet 1304 is not registered to the flow table 101.

After the three above-mentioned IP packets 1301a, 1302a, and 1304 have been inputted, the flow table 101 becomes as shown in FIG. 5(a).

An entry 1401 a corresponds to a flow of the IP packet 1301a, and an entry 1401b corresponds to a flow of the IP packet 1302a. Since an IP packet 1302b is a non-head fragmented packet (step 401), when the IP packet 1302b is inputted into the outputting interface 1102n of the packet-relaying device 1100 as shown in FIG. 3, the flow-determining unit 104 searches the flow table 101 for an entry relating to the IP packet 1302b (step 405). There is an entry 1401b whose source IP address, destination IP address, protocol number, and identification are all equal to those of the IP header of the IP packet 1302b. And class information thereof shows the high priority. Therefore, the flow-determining unit 104 outputs the IP packet 1302b into the queue 108 for the high priority class (step 406).

Since an IP packet 1303b is a non-head fragmented packet (step 401), when the IP packet 1303b is inputted into the outputting interface 1102n of the packet-relaying device 1100, the flow-determining unit 104 searches the flow table 101 for an entry relating to the IP packet 1303b (step 405). There is not an entry whose source IP address, destination IP address, protocol number, and identification are all equal to those of the IP header of the IP packet 1303b. Therefore, the flow-determining unit 104 outputs the IP packet 1303b into the queue 109 for the low priority class (step 409).

Since an IP packet 1302c is a non-head fragmented packet (step 401), when the IP packet 1302c is inputted into the outputting interface 1102n of the packet-relaying device 1100, the flow-determining unit 104 searches the flow table 101 for an entry relating to the IP packet 1302c (step 405). There is an entry 1401b whose source IP address, destination IP address, protocol number, and identification are all equal to those of the IP header of the IP packet 1302c. And, class information thereof shows the high priority. Therefore, the flow-determining unit 104 outputs the IP packet 1302c into the queue 108 for the high priority class (step 406).

Since the IP packet 1302c is a final non-head fragmented packet (step 407), the first flow table-deleting unit 303 deletes the entry 1401b relating to the IP packet 1302c from the flow table 101 (step 408). When the entry is deleted from the first flow table-deleting unit 303, the flow table 101 is changed from that of FIG. 5(a) to that of FIG. 5(b).

When no packet relating to an entry 1402b has reached for predetermined time since a state of FIG. 5(b), the entry will be deleted by the second flow-table deleting unit 106.

Packets, which are classified into one of the high priority class and the low priority class and are outputted into one of the queues 108 and 109 corresponding to the class thereof, are transmitted using the PQ method such that packets classified into the high priority class are more preferential than those classified into the low priority class.

### Embodiment 2

Next, an embodiment 2 of the present invention will now be explained. This embodiment corresponds to RTP packets.

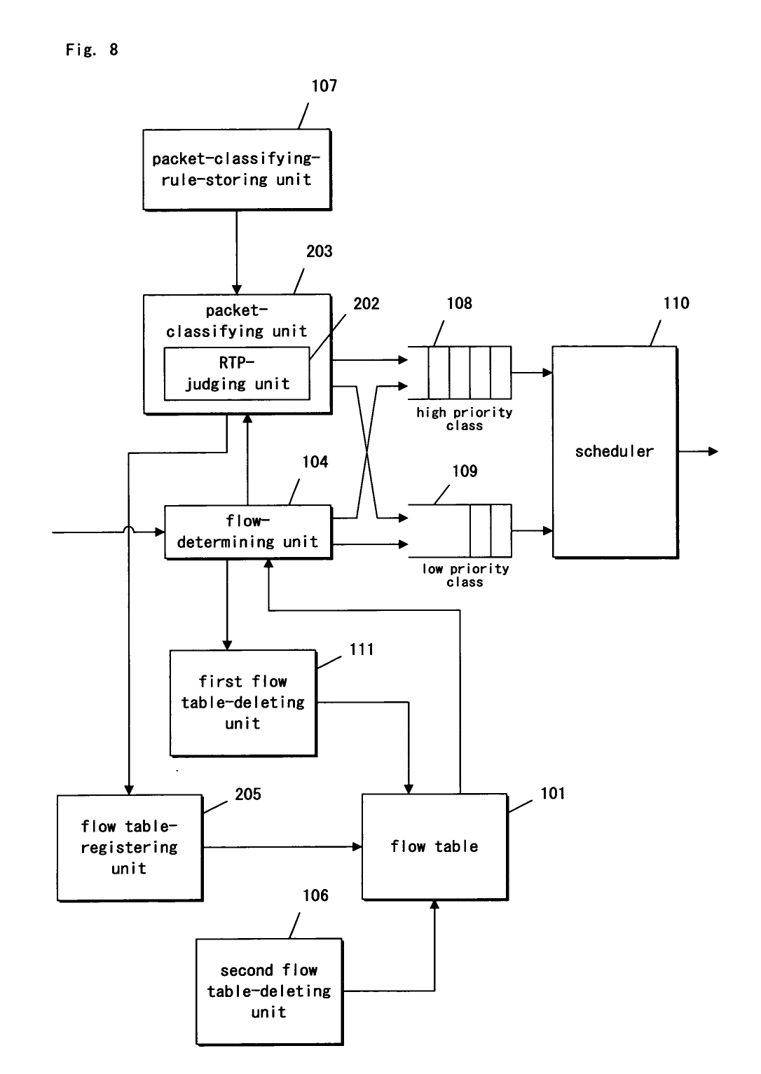

FIG. 8 is a block diagram of an outputting interface 1102n block diagram in the embodiment 2 of the present invention. In FIG. 8, explanation of components same as shown in FIG. 2 are omitted attaching same symbols as in FIG. 2.

A packet-classifying unit 203 comprises an RTP-judging unit 202 that judges whether or not an inputted packet is an RTP packet. When the RTP-judging unit 202 judges the inputted packet is an RTP packet, the packet-classifying unit 203 outputs the inputted packet into the queue 108. More specifically, the RTP-judging unit 202 judges whether a port number of a UDP header of the inputted IP packet is an even number that is a value of “1024” or more.

When the port number of the UDP header of the inputted IP packet is an even number that is “1024” or more, the RTP packet judging unit 202 judges that an RTP header continues after the UDP header. Furthermore, when a predetermined value is set in a version field indicating a protocol version and a predetermined value is set in a payload type field of an RTP payload, the RTP-judging unit 202 judges that an RTP packet is included in the inputted IP packet.

When the RTP-judging unit 202 judges that an RTP packet is included in the inputted IP packet, the flow table-registering unit 205 registers a new entry to the flow table 101. The new entry has a source IP address, a destination IP address, and a protocol number, which are all equal to those of an IP header of the inputted IP packet. A port number of the new entry is the sum of a port number of the TCP/UDP header and “1”.

In the packet-classifying-rule-storing unit 107, a rule of “An IP packet containing an RTP packet should be processed with the high priority”, and a rule of “An IP packet containing an RTCP packet should be processed with the high priority” are defined.

Also in this embodiment, every entry of the flow table 101 has class information to be classified.

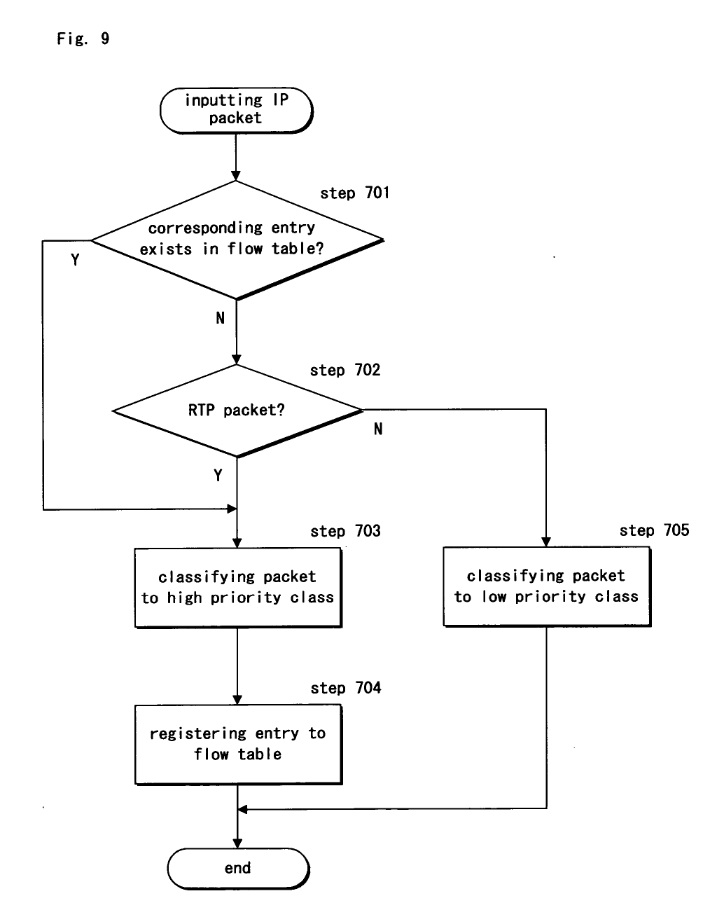

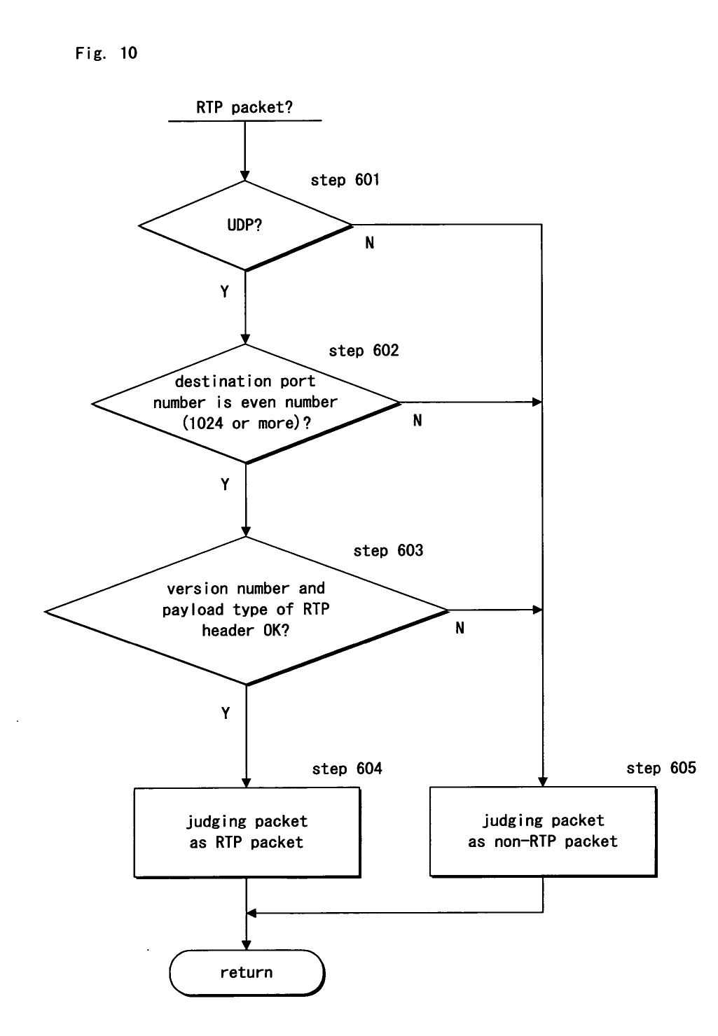

Referring now to FIG. 9 and FIG. 10, flow of processes will be explained.

When an IP packet is inputted into the outputting interface 1102n of the packet-relaying device 1100, the flow-determining unit 104 searches the flow table 101 for an entry whose source IP address, destination IP address, protocol number, and port number of the TCP/UDP header are all equal to those of the IP header of the inputted IP packet (step 701).

When the entry is not found, the flow-determining unit 104 outputs the IP packet to the packet-classifying unit 203. The RTP-judging unit 202 judges whether or not the inputted IP packet includes an RTP packet (step 702).

In this embodiment, the RTP-judging unit 202 judges the inputted IP packet includes an RTP packet when all of the following conditions are fulfilled: (1) a value of a bit string corresponding to a version field of an RTP header is “2”; and (2) a value of a bit string corresponding to a payload type field is not less than “0” and not greater than “34”, or not less than “96” and not greater than “127”.

As shown in FIG. 10, the RTP-judging unit 202 checks whether or not an inputted IP packet is a UDP packet (step 601).

When the inputted IP packet is a UDP packet, the RTP-judging unit 202 checks whether or not a port number of a UDP header of the inputted IP packet is an even number that is “1024” or more (step 602).

When the port number is an even number that is “1024” or more, the RTP-judging unit 202 checks whether or not all of the following conditions are fulfilled: (a) a value of a bit string corresponding to a version field of an RTP header is “2”; and (b) a value of a bit string corresponding to a payload type field is not less than “0” and not greater than “34”, or not less than “96” and not greater than “127” (step 603). When all of the conditions are fulfilled, the RTP-judging unit 202 judges that the inputted IP packet includes an RTP packet (step 604).

When at least one of the conditions is not fulfilled, the RTP-judging unit 202 judges that the inputted IP packet does not include an RTP packet (step 605).

In FIG. 9, when it is judged that the inputted IP packet includes an RTP packet, the packet-classifying unit 203 outputs the inputted IP packet into the queue 108 for the high priority class (step 703).

Furthermore, the flow table-registering unit 205 registers a new entry to the flow table 101. The new entry has a source IP address, a destination IP address, and a protocol number, which are all equal to those of an IP header of the inputted IP packet. A port number of the new entry is the sum of a port number of the TCP/UDP header and “1”. Class information of the new entry is class information that has been allocated for RTCP beforehand (step 704).

In step 702, when the RTP-judging unit 202 judges that the inputted IP packet does not include an RTP packet, the packet-classifying unit 203 outputs the inputted IP packet into the queue 109 for the low priority class (step 705).

When the packet 1304 shown in FIG. 3 includes an RTP packet and the packet 1304 has just been inputted, the flow table 101 becomes as shown in FIG. 5(c).

### Embodiment 3

An embodiment 3 of the present invention will now be explained. This embodiment corresponds to fragmentation and RTP packets.

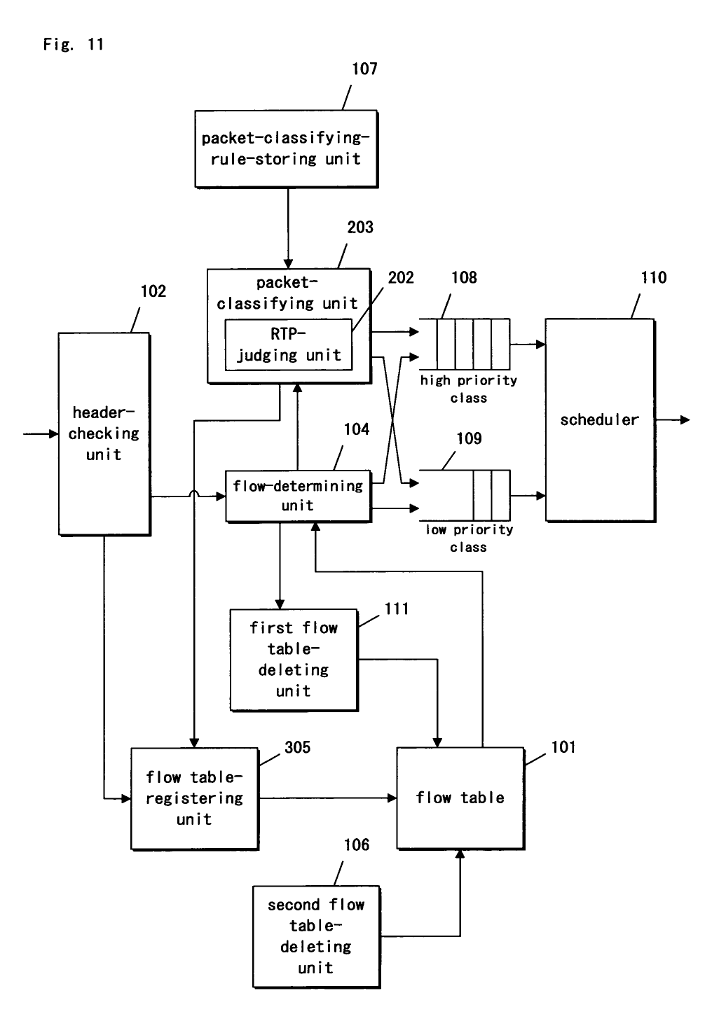

FIG. 11 is a block diagram of an outputting interface 1102n in the embodiment 3 of the present invention. In FIG. 11, explanation of components same as shown in FIG. 2 or FIG. 8 are omitted attaching same symbols as in FIG. 2 or FIG. 8.

The header-checking unit 102 checks whether or not an inputted IP packet is a non-head fragmented packet. However, dissimilar to the embodiment 1, the header-checking unit 102 outputs the inputted IP packet to the flow-determining unit 104 regardless of check result thereof. Also in this embodiment, every entry of the flow table 101 has class information to be classified.

Similar to the embodiment 2, in the packet-classifying-rule-storing unit 107, a rule of “An IP packet containing an RTP packet should be processed with the high priority”, and a rule of “An IP packet containing an RTCP packet should be processed with the high priority” are defined.

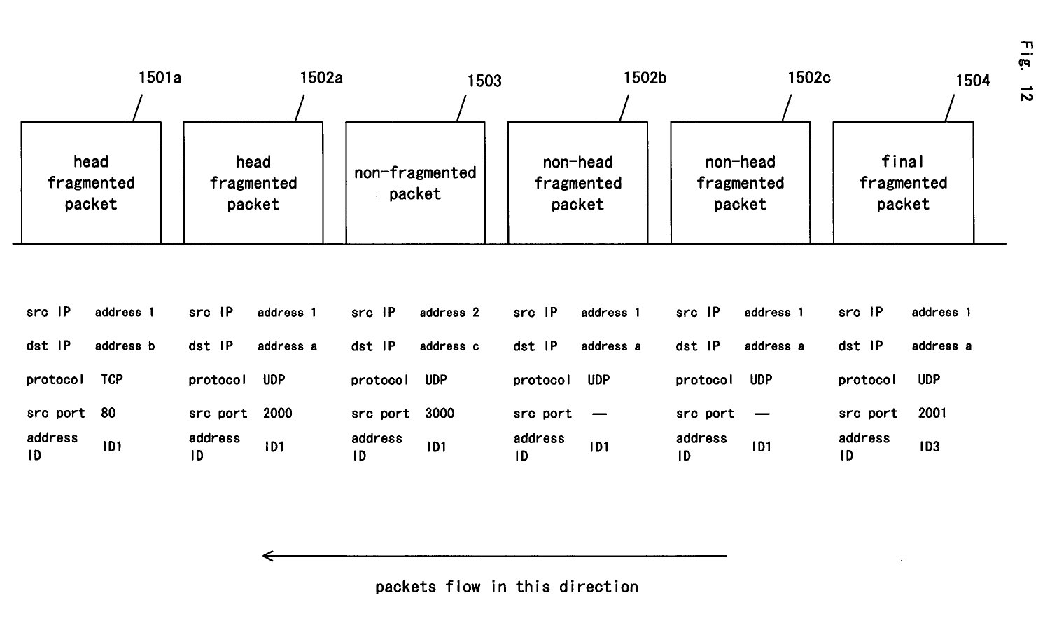

Referring now to FIG. 12 to FIG. 14, an example of operation in this embodiment will now be explained.

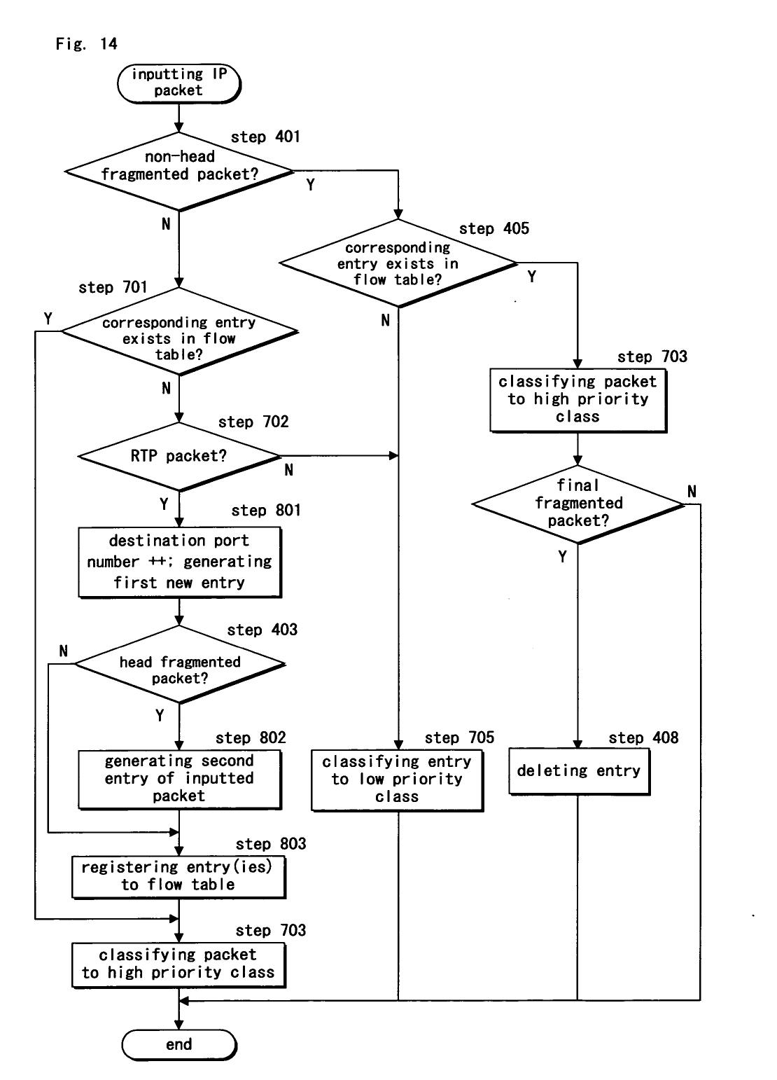

FIG. 14 shows how the outputting interface 1102n in the embodiment 3 determines a class of an IP packet. FIG. 14 includes partially same processes as shown in FIG. 6. Processes in FIG. 14 except steps 801 to 803 are same as in FIG. 6 or FIG. 9. 202 FIG. 12 illustrates a flow of IP packets inputted into the outputting interface 1102n of the packet-relaying device 1100. In FIG. 12, IP packets 1502a, 1502b, and 1502c are fragmented and divided from one IP packet including an RTP packet.

The IP packet 1502a is a head fragmented packet, the IP packet 1502b is a second (non-head, non-final) fragmented packet, and the IP packet 1502c is a third (non-head, final) fragmented packet.

An IP packet 1501 a is a head fragmented packet not including an RTP packet, and second and subsequent fragmented packets have not yet reached to the packet-relaying device 1100.

An IP packet 1503 is a non-fragmented IP packet including an RTP packet. An IP packet 1504 is an IP packet including an RTCP packet for controlling a flow to which RTP packets (the IP packets 1502a, 1502b, and 1502c) belong.

Referring now to FIG. 12 and FIG. 14, an example of operation will now be explained.

As shown in FIG. 12, when the IP packet 1501a is inputted to the outputting interface 1102n of the packet-relaying device 1100, the header-checking unit 102 checks whether or not each of these IP packets 1301a and 1302a is a non-head fragmented packet (step 401). The header-checking unit 102 outputs the IP packet 1501a to the flow-determining unit 104 after the checking, regardless checking result thereof.

Herein, since the IP packet 1501a is a head fragmented packet, processes moves to step 701. At this time, since there is no entry in the flow table 101, the RTP-judging unit 202 checks whether the IP packet 1501a includes an RTP packet (step 702). Furthermore, it is judged that the IP packet 1501a does not include an RTP packet (steps 601 and 605), and the IP packet 1501a is outputted into the queue 109 for the low priority class (step 705).

As shown in FIG. 12, since the IP packet 1502a is not a non-head fragmented packet (step 401), when the IP packet 1502a is inputted to the outputting interface 1102n of the packet-relaying device 1100, the flow-determining unit 104 searches the flow table 101.

Also at this time, since there is no entry in the flow table 101, the flow-determining unit 104 outputs the IP packet 1502a to the packet-classifying unit 203 and the RTP-judging unit 202 checks whether or not the IP packet 1502a includes an RTP packet (step 702).

Herein, it is judged that the IP packet 1502a includes an RTP packet. The flow table-registering unit 305 registers a new entry 1601b to the flow table 101 (step 801). The new entry 1601b has a source IP address, a destination IP address, and a protocol number, which are all equal to those of the IP header of the inputted IP packet 1502a. A port number of the new entry 1601b is the sum of a port number of the TCP/UDP header and “1”. Class information of the new entry 1601b is class information allocated to IP packets each including an RTCP packet.

Since the inputted IP packet 1502a is also a head fragmented packet, the flow table-registering unit 305 registers another new entry 1601a to the flow table 101 (step 802). The new entry 1601 a has a source IP address, a destination IP address, a protocol number, and an identification, which are all equal to those of the IP header of the inputted IP packet 1502a. Class information of the new entry 1601 a is class information allocated to IP packets including an RTP packet. In this case, two new entries 1601 a and 1601b are registered into the flow table 101 at one time (step 803).

Since the IP packet 1503 includes an RTP packet (step 604), when the IP packet 1503 is inputted into the outputting interface 1102n of the packet-relaying device 1100 as shown in FIG. 12, the flow table-registering unit 305 registers a new entry 1601c (step 801). The new entry 1601c has a source IP address, a destination IP address, and a protocol number, which are all equal to those of an IP header of the inputted IP packet 1503. A port number of the new entry 1601c is the sum of a port number of a TCP/UDP header of the IP packet 1503 and “1”. Class information of the new entry 1601c is class information allocated to IP packets including an RTCP packet.

Since the inputted IP packet 1503 is not a head fragmented packet (step 403), one new entry 1601c is registered to the flow table 101 (step 803).

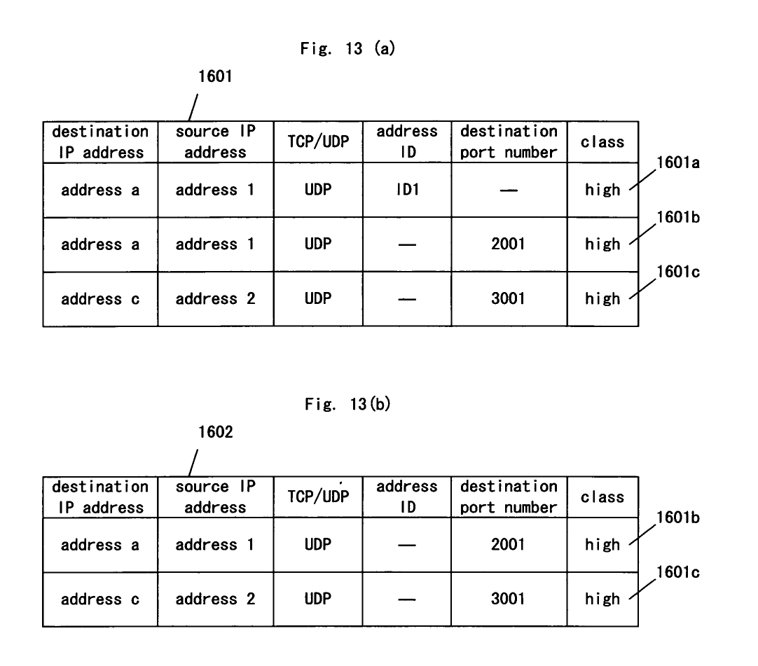

After the three above-mentioned IP packets 1501a, 1502a, and 1503 have been inputted, the flow table 101 becomes as shown in FIG. 13(a). The entries 1601a and 1601b are entries created as the result of the IP packet 1502a, and the entry 1601c is an entry created as the result of the IP packet 1503.

Since an IP packet 1502b is a non-head fragmented packet (step 401), when the IP packet 1502b is inputted into the outputting interface 1102n of the packet-relaying device 1100, the flow-determining unit 104 searches the flow table 101 for an entry relating to the IP packet 1502b (step 405).

There is an entry 1601b whose source IP address, destination IP address, protocol number, and identification are all equal to those of the IP header of the IP packet 1502b. And class information thereof shows the high priority. Therefore, the flow-determining unit 104 outputs the IP packet 1502b into the queue 108 for the high priority class (step 703).

Since an IP packet 1502c is a non-head fragmented packet (step 401), when the IP packet 1502c is inputted into the outputting interface 1102n of the packet-relaying device 1100, the flow-determining unit 104 searches the flow table 101 for an entry relating to the IP packet 1502c (step 405), as described in the embodiment 1.

There is an entry 1601b relating to the IP packet 1502c in the flow table 101. And class information thereof shows the high priority. Therefore, the flow-determining unit 104 stores the IP packet 1502c in the queue 108 for the high priority class (step 703).

Since the IP packet 1502c is a final non-head fragmented packet (step 407), the first flow table-deleting unit 111 deletes the entry 1601 a from the flow table 101 (step 408).

Consequently, the flow table 101 is changed from FIG. 13(a) to FIG. 13(b).

Since an IP packet 1504 is not a non-head fragmented packet (step 401), when the IP packet 1504 is inputted into the outputting interface 1102n of the packet-relaying device 1100, the flow-determining unit 104 searches the flow table 101 for an entry relating to the IP packet 1504 (step 405).

As shown in FIG. 13(b), there is an entry 1601b whose source IP address, destination IP address, protocol number, and identification are all equal to those of the IP header of the IP packet 1504. And class information thereof shows the high priority. Therefore, the flow-determining unit 104 stores the IP packet 1504 in the queue 108 for the high priority class (step 703).

### Embodiment 4

An embodiment 4 of the present invention will now be explained. This embodiment corresponds to AV packets.

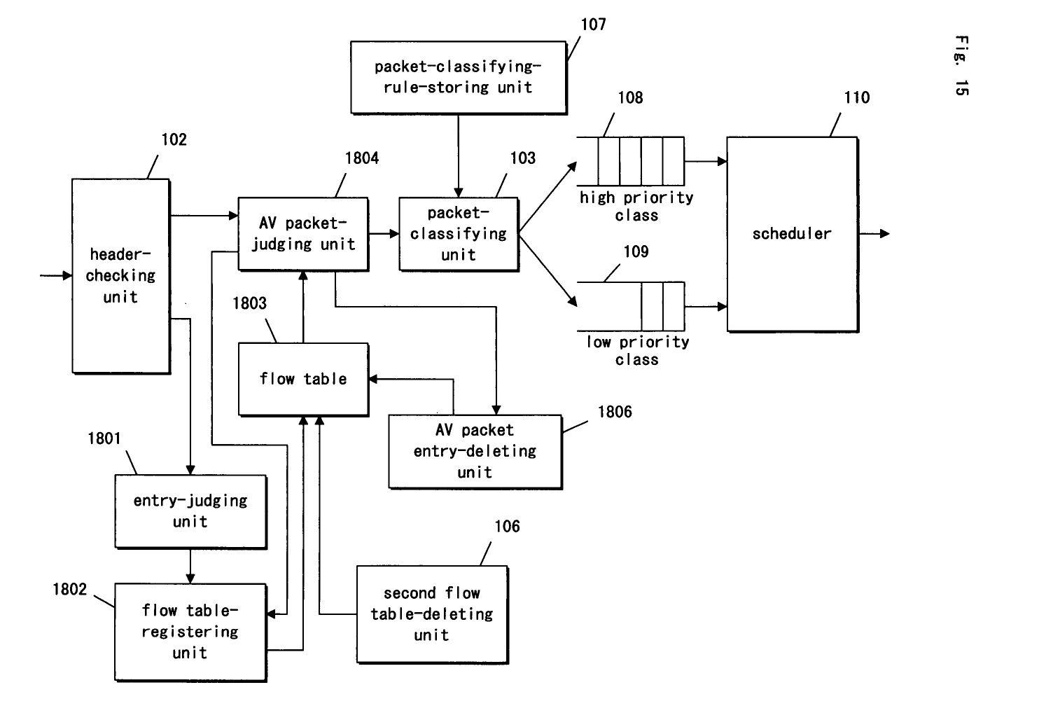

FIG. 15 is a block diagram of an outputting interface 1102n in the embodiment 4 of the present invention. In FIG. 15, explanation of components same as shown in FIG. 2 are omitted attaching same symbols as in FIG. 2. In FIG. 15, information of a packet inputted into the outputting interface 1102n is stored in a flow table 1803.

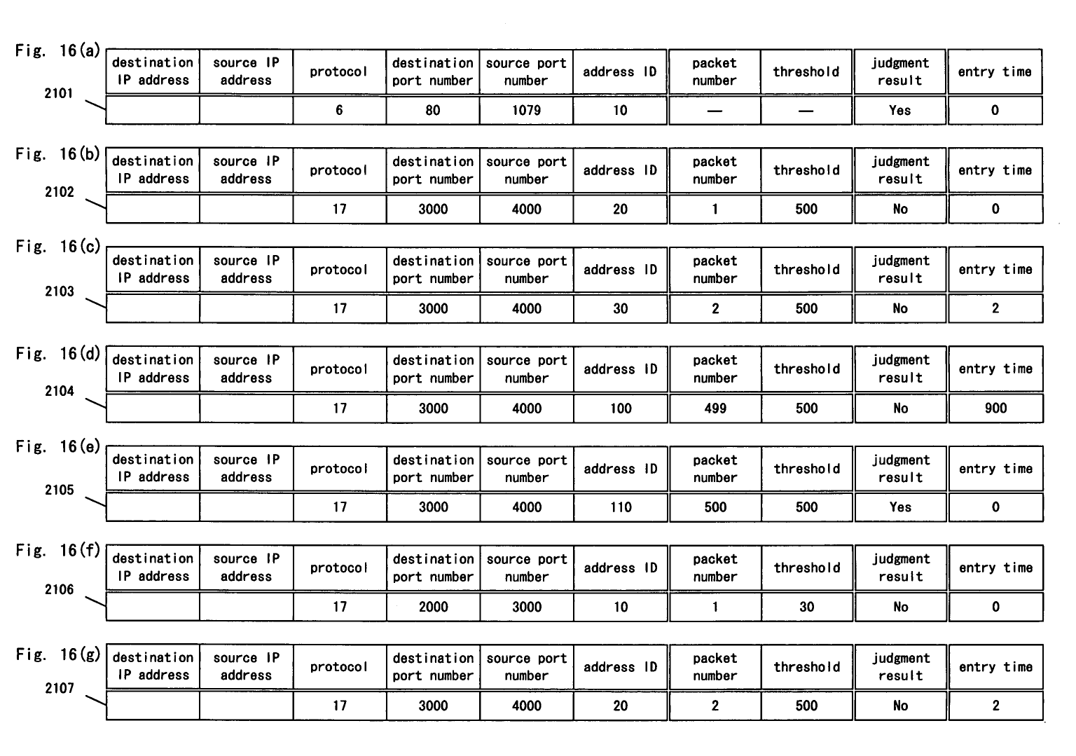

As shown in FIG. 16, every entry of the flow table 1803 has the following fields: a source IP address; a destination IP address; a protocol number; an identification; and a port number. All of values of the fields are included in a TCP/UDP header of an IP packet.

Furthermore, every entry of the flow table 1803 has the following fields: a number of packets that have reached to the outputting interface 1102n within predetermined time; an AV threshold; and information indicating when this entry has registered into the flow table 1803.

In FIG. 15, an entry-judging unit 1801 judges whether or not an inputted packet is an object of an entry of the flow table 1803. In this embodiment, when a higher-level protocol of IP of the inputted packet is the UDP, the entry-judging unit 1801 judges the inputted packet is the object of an entry of the flow table 1803. Herein, the inputted packet is an object that is judged whether or not it is an AV packet, that is, a candidate of an AV packet.

The flow table-registering unit 1802 registers information of flow relating to the inputted IP packet into the flow table 1803. In this embodiment, an entry judged that is not a flow of AV packets is also registered into the flow table 1803. 231 The AV packet-judging unit 1804 judges that an inputted packet is an AV packet, when the following conditions are fulfilled: (1) the inputted packet is registered in the flow table 1803; (2) the inputted packet is indicated being a non-AV packet; and (3) the inputted packet has continuously reached to the outputting interface 1102n for predetermined time.

The AV packet-judging unit 1804 checks a value of “Content-Type” of an HTTP packet, which shows a data type of thereof, and judges whether or not the HTTP packet is an AV packet.

The AV packet-judging unit 1804 judges that the HTTP packet is an AV packet, when a value of “Content-Type” of the HTTP packet is “audio/*” or “video/*” (where the symbol of “*” is a wild card). Otherwise, for example, when a value of “Content-Type” is “text”, the AV packet-judging unit 1804 judges that the HTTP packet is not an AV packet.

When the AV packet-judging unit 1804 judges that an HTTP packet is an AV packet according to a value of “Content-Type” thereof and further that a flow relating to the HTTP packet has not been registered into the flow table 1803 yet, the flow table-registering unit 1802 registers an entry relating to the flow relating to the HTTP packet. The entry has a destination IP address, a source IP address, a protocol number, a destination port number, a source port number, and an identification, which are all included in the HTTP packet.

When an inputted IP packet is contradictory to contents of an entry of the flow table 1803, the AV packet entry-deleting unit 1806 deletes this entry from the flow table 1803.

In this embodiment, concerning an entry being registered in the flow table 1803, when packet size of an inputted IP packet is different from that of the entry, it is judged that the inputted IP packet is contradictory to contents of the entry.

The AV packet entry-deleting unit 1806 corresponds to an item-deleting unit. The item-deleting unit deletes information of a flow from the flow table 1803, when a packet belonging to a flow defined in the flow table 1803 is inputted and the size of the inputted packet is different from that of the flow defined in the flow table 1803.

Referring to a judgment result by the AV packet-judging unit 1804 and the packet-classifying-rule-storing unit 107, the packet-classifying unit 103 outputs the inputted IP packet into a queue of a corresponding class.

FIG. 16(a) to FIG. 16(g) show contents of the flow table 1803 at a certain time. A unit of entry time is a millisecond.

In this embodiment, when packet size of an inputted IP packet is 250 bytes or less, the inputted IP packet is handled as a candidate of an audio packet. And, when packet size of an inputted IP packet is no less than 250, the inputted IP packet is handled as a candidate of a video packet.

In this embodiment, for judging whether or not inputted IP packets continue, the following AV thresholds are used. An AV threshold for audio packets is 30 pieces per second. And, an AV threshold for video packets is 500 pieces per second.

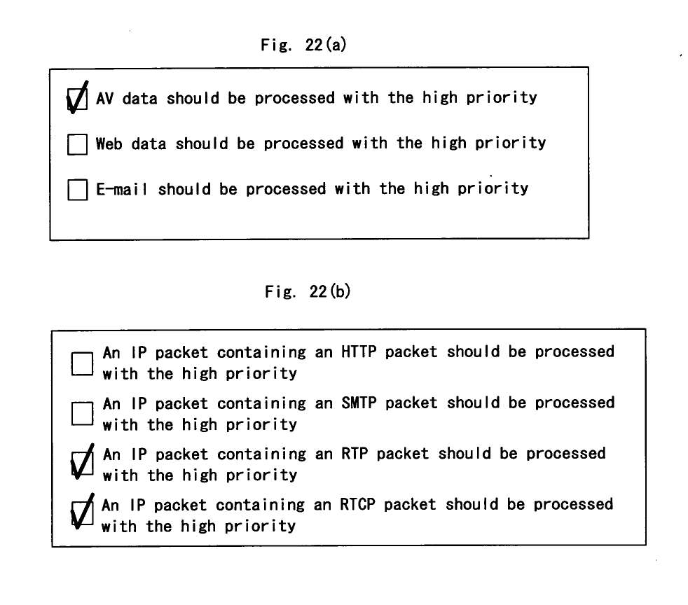

It is assumed that a rule of “AV data should be processed with high priority” is defined in the packet-classifying-rule-storing unit 107 as shown in FIG. 22(a).

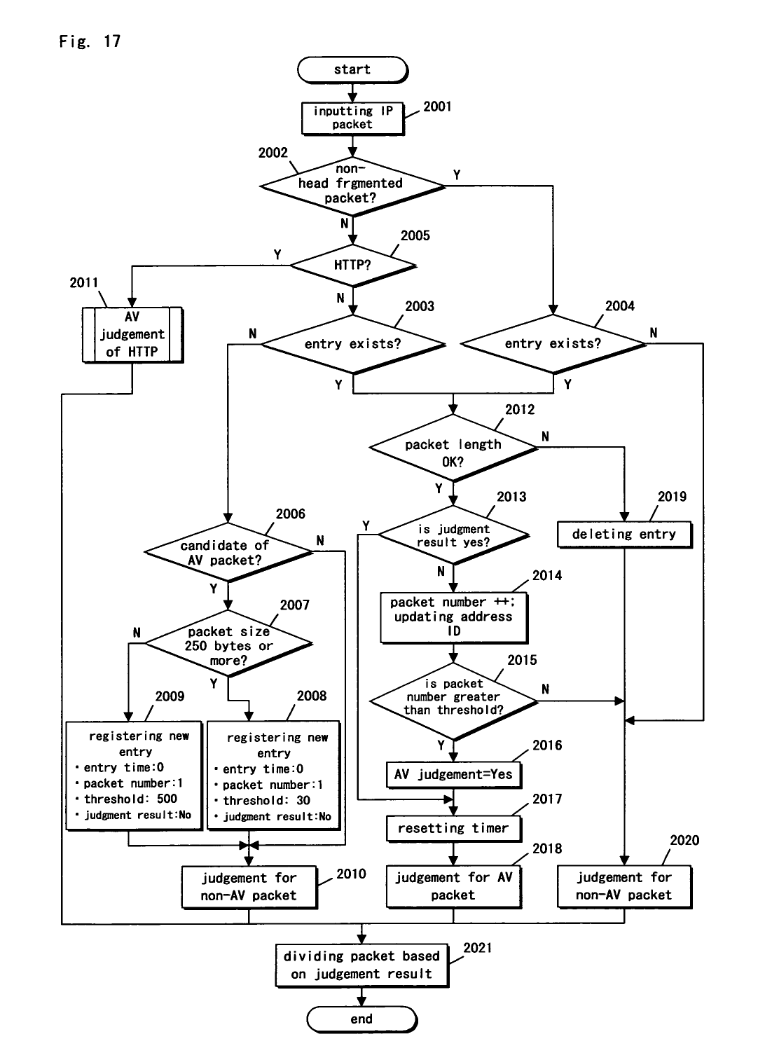

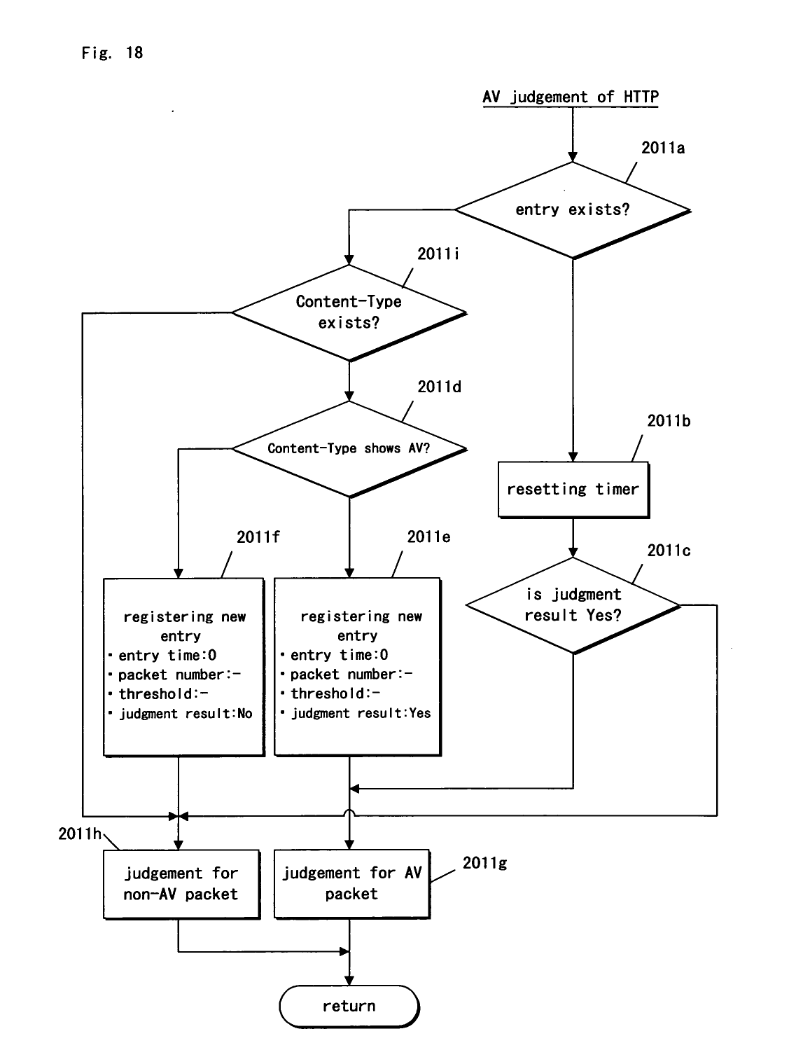

FIG. 17 is a flow chart of an outputting interface 1102n in the embodiment 4 of the present invention, and FIG. 18 shows AV judging processes of FIG. 17. Processes in this embodiment will now be explained, illustrating some cases.

(Case 1): The flow table 1803 is empty; an IP packet is inputted into the outputting interface 1102n; the inputted packet is not a non-head fragmented packet; the inputted packet includes an HTTP packet; and “Content-Type” of the inputted packet is “video/*” or “audio/*” (steps 2001 and 2002).

In FIG. 17, since the inputted IP packet includes the HTTP packet (step 2005), processes move to step 2011. In this case, since the flow table 1803 has no entry as shown in FIG. 18 (step 2011a), the AV packet-judging unit 1804 checks whether or not information of “Content-Type” of the HTTP packet exists (step 2011i). When it does not exist, the AV packet-judging unit 1804 judges that this packet is not an AV packet (step 2011h). When it exists, processes move to step 2011d.

Herein, since “Content-Type” of the HTTP packet is “video/*” or “audio/*” in step 2011d, processes move to step 2011e. And, the flow table-registering unit 1802 registers an entry to the flow table 1803. The entry has the following fields: a destination IP address; a source IP address; a protocol number; a destination port number; a source port number; and an identification. All of values of the fields are included in the IP header of the inputted IP packet.

At step 2011g, the AV packet-judging unit 1804 judges that the packet is an AV packet. In FIG. 16(a), since this IP packet has just been judged to be an AV packet and has been registered, entry time relating to this IP packet is “0” and the judgment result of this IP packet is “Yes.” Herein, a symbol of “-” means “don't care”.

At step 2021 of FIG. 17, referring to a judgment result by the AV packet-judging unit 1804 and the packet-classifying-rule-storing unit 107, the packet-classifying unit 103 outputs the inputted IP packet into a queue of a corresponding class. Herein, since the inputted IP packet has been judged to be an AV packet, the packet-classifying unit 1805 outputs the inputted IP packet into the queue 108.

(Case 2): The flow table 1803 is empty; an IP packet is inputted into the outputting interface 1102n; the inputted packet is not a non-head fragmented packet; the inputted packet includes an HTTP packet; and “Content-Type” of the inputted packet is neither “video/*” nor “audio/*” (steps 2001 and 2002).

In FIG. 17, since the inputted IP packet includes the HTTP packet (step 2005), processes move to step 2011. In this case, since the flow table 1803 has no entry as shown in FIG. 18 (step 2011a), the AV packet-judging unit 1804 checks whether or not information of “Content-Type” of the HTTP packet exists (step 2011i).

When the information does not exist, the AV packet-judging unit 1804 judges that this packet is not an AV packet (step 2011h). When it exists, processes move to step 2011d.

Herein, since “Content-Type” of the HTTP packet is neither “video/*” nor “audio/*” in step 2011 d, processes move to step 2011f. And, the flow table-registering unit 1802 registers an entry to the flow table 1803. The entry has the following fields: a destination IP address; a source IP address; a protocol number; a destination port number; a source port number; and an identification. All of values of the fields are included in the IP header of the inputted IP packet.

At step 2011h, the AV packet-judging unit 1804 judges that the packet is not an AV packet. Contents of the registered entry are what the judgment result thereof is replaced “Yes” with “No” in FIG. 16(a).

In this embodiment, when there is no information of “Context-Type” in an HTTP packet, the inputted IP packet is judged to be not an AV packet like in step 2011f. However, in that case, if needed, the inputted IP packet may be judged to be an AV packet.

At step 2021 of FIG. 17, referring to a judgment result by the AV packet-judging unit 1804 and the packet-classifying-rule-storing unit 107, the packet-classifying unit 103 outputs the inputted IP packet into a queue of a corresponding class. Herein, since the inputted IP packet has been judged to be not an AV packet, the packet-classifying unit 1805 outputs the inputted IP packet into the queue 109.

(Case 3): The flow table 1803 is in a state of FIG. 16(a); entry time of an entry 2101 is beyond predetermined time; an IP packet is inputted into the outputting interface 1102n; the inputted packet is not a non-head fragmented packet; and the inputted packet corresponds to the entry 2101. That is, all of a destination IP address; a source IP address; a protocol number; a destination port number; a source port number; and an identification of the entry 2101 are included in the IP header of the inputted IP packet (steps 2001 and 2002).

In FIG. 17, this packet includes an HTTP packet (step 2011), and in FIG. 18, the flow table has an entry relating to this packet (step 2011a). Therefore, in step 2011b, the flow table-registering unit 1802 resets entry time of the entry to “0.”

In step 2011c, since a judgment result of this entry is “Yes”, processes move to step 2011g and this packet is judged to be an AV packet. At step 2021 of FIG. 17, the packet-classifying unit 1805 outputs this packet into the queue 108.

(Case 4): The flow table 1803 is empty; an IP packet is inputted into the outputting interface 1102n; the inputted packet is not a non-head fragmented packet; packet size of the inputted packet is 1000 bytes; and a higher-level protocol of the inputted packet is the UDP (steps 2001 and 2002).

In FIG. 17, since the inputted IP packet does not include an HTTP packet (step 2005) and the flow table 1803 has no corresponding entry thereto (step 2003), the entry-judging unit 1801 checks whether or not this packet is an object of an entry of the flow table 1803.

In this example, it is considered that the inputted packet is an object of an entry of the flow table 1803 when the higher-level protocol of an IP packet is the UDP. Therefore, this packet is judged to be a candidate of an AV packet, and processes move to step 2007.

Since packet size of this packet is 1000 bytes, processes move from step 2007 to step 2009. That is, as shown in FIG. 16 (b), a new entry relating to this packet is registered into the flow table 1803, and an AV threshold of the new entry is set up with “500”, which shows this packet is a candidate of a video packet.

(Case 5): The flow table 1803 is in a state of FIG. 16(b); an IP packet is inputted into the outputting interface 1102n; the inputted packet is not a non-head fragmented packet (step 2002); packet size of the inputted packet is 1000 bytes; and the inputted packet corresponds to an entry 2102. That is, all of a source IP address; a destination IP address; a protocol number; a source port number; and a destination port number of the entry 2102 are included in an IP header of the inputted IP packet (steps 2003).

At step 2012 of FIG. 17, the entry 2102 has been registered as a candidate of a video packet, and the packet size of the inputted IP packet is 1000 bytes. Therefore, the inputted IP packet corresponds to a condition for a candidate of a video packet.

At this time, a judgment result of the entry 2102, which shows whether or not this packet is an AV packet, is “No” (step 2013). Therefore, a value of “1” is added to a packet number of the entry 2102, and a value of an identification of the entry 2102 is updated to a value of that of the inputted IP packet (step 2014). This updating changes the entry 2102 to an entry 2103 of FIG. 16(c).

The AV packet-judging unit 1804 compares an AV threshold of “500” of the entry 2103 with a packet number of “2”, and judges that the inputted IP packet is not an AV packet (step 2020).

However, as stated below referring to the next case, when the packet number is added continuously, the packet number will reach to the AV threshold in the future, and the judgment result will change from “No” to “Yes.”

(Case 6): The flow table 1803 is in a state of FIG. 16(d); an IP packet is inputted into the outputting interface 1102n; the inputted packet is not a non-head fragmented packet (step 2002); packet size of the inputted packet is 1000 bytes; and the inputted packet corresponds to an entry 2104. That is, all of a source IP address; a destination IP address; a protocol number; a source port number; and a destination port number of the entry 2104 are included in the IP header of the inputted IP packet (steps 2003).

At step 2012 of FIG. 17, the entry 2104 has been registered as a candidate of a video packet, and the packet size of the inputted IP packet is 1000 bytes. Therefore, the inputted IP packet corresponds to a condition for a candidate of a video packet.

At this time, a judgment result of the entry 2104, which shows whether or not this packet is an AV packet, is “No” (step 2013). Therefore, a value of “1” is added to a packet number of the entry 2104, and a value of an identification of the entry 2104 is updated to a value of that of the inputted IP packet (step 2014).

The AV packet-judging unit 1804 compares an AV threshold of “500” of the entry 2103 with a packet number of “500”, which has been just added a value of “1” (step 2015), and changes the judgment result from “No” to “Yes” (step 2016). Furthermore, the AV packet-judging unit 1804 sets a value of “0” to the entry time (step 2017), and judges that this packet is an AV packet (step 2018). These processes change the entry 2104 to an entry 2105 of FIG. 16(e).

(Case 7): The flow table 1803 is empty; an IP packet is inputted into the outputting interface 1102n; the inputted packet is not a non-head fragmented packet; packet size of the inputted packet is 200 bytes; and a higher-level protocol of the inputted packet is the UDP (steps 2001 and 2002).

At step 2007 of FIG. 17, since the packet size of the inputted IP packet is 200 bytes, an entry relating to the inputted packet is registered as a candidate of an audio packet (step 2008) as shown in FIG. 16(f).

The inputted IP packet is judged to be not an AV packet (step 2010), and the packet-classifying unit 1805 outputs the inputted IP packet into the queue 109 (step 2017).

(Case 8): The flow table 1803 is in a state of FIG. 16(f); an IP packet is inputted into the outputting interface 1102n; the inputted packet is not a non-head fragmented packet (step 2002); packet size of the inputted packet is 1000 bytes; and the inputted packet corresponds to an entry 2106. That is, all of a source IP address; a destination IP address; a protocol number; a source port number; and a destination port number of the entry 2106 are included in the IP header of the inputted IP packet (steps 2003).

Although the entry 2106 has been registered as a candidate of an audio packet, at step 2012 of FIG. 17, the packet size of the inputted IP packet is 1000 bytes, and the packet size does not correspond to a condition to be a candidate of an audio packet.

In this case, it is judged that contradiction exists. Therefore, the AV packet entry-deleting unit 1806 deletes the entry 2106 from the flow table 1803 (step 2019), and the inputted packet is judged to be not an AV packet (step 2020).

(Case 9): The flow table 1803 is in a state of FIG. 16(b); an IP packet is inputted into the outputting interface 1102n; the inputted packet is not a non-head fragmented packet (step 2002); and packet size of the inputted packet is 1000 bytes.

At step 2004 of FIG. 17, when the inputted IP packet corresponds to the entry 2102, that is, all of a source IP address; a destination IP address; a protocol number; a source port number; an a destination port number of the entry 2102 are included in the IP header of the inputted IP packet, the entry 2102 changes to an entry 2107 of FIG. 16(g) (steps 2012 to 2015). An identification thereof is the same of that of the entry 2102. The inputted IP packet is judged to be not an AV packet (step 2020).

When the inputted IP packet does not correspond to the entry 2102 (step 2004), the inputted IP packet is judged to be not an AV packet (step 2020).

The second flow table-deleting unit 106 is the same as that of the embodiment 1 (See FIG. 5). Herein, it is preferable to make the predetermined time 1000 milliseconds, for example.

### Embodiment 5

An embodiment 5 of the present invention will now be explained. This embodiment corresponds to RTP/RTCP packets.

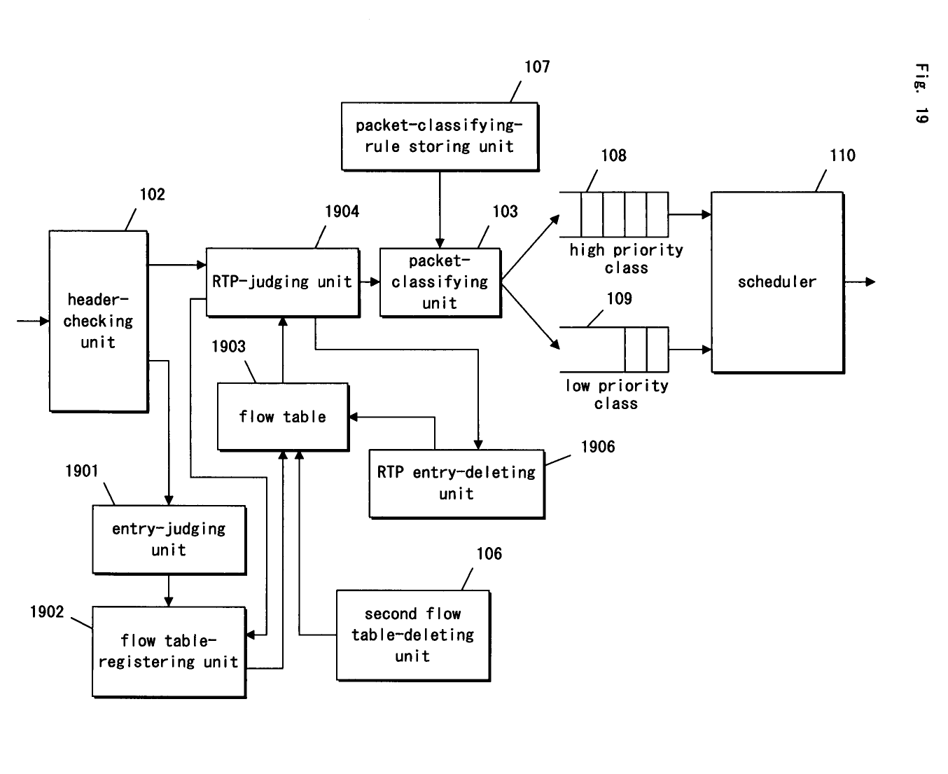

FIG. 19 is a block diagram of an outputting interface 1102n in the embodiment 5 of the present invention. In FIG. 19, explanation of components same as shown in FIG. 2 are omitted attaching same symbols as in FIG. 2. In FIG. 19, information of a packet inputted into the outputting interface 1102n is stored in a flow table 1903.

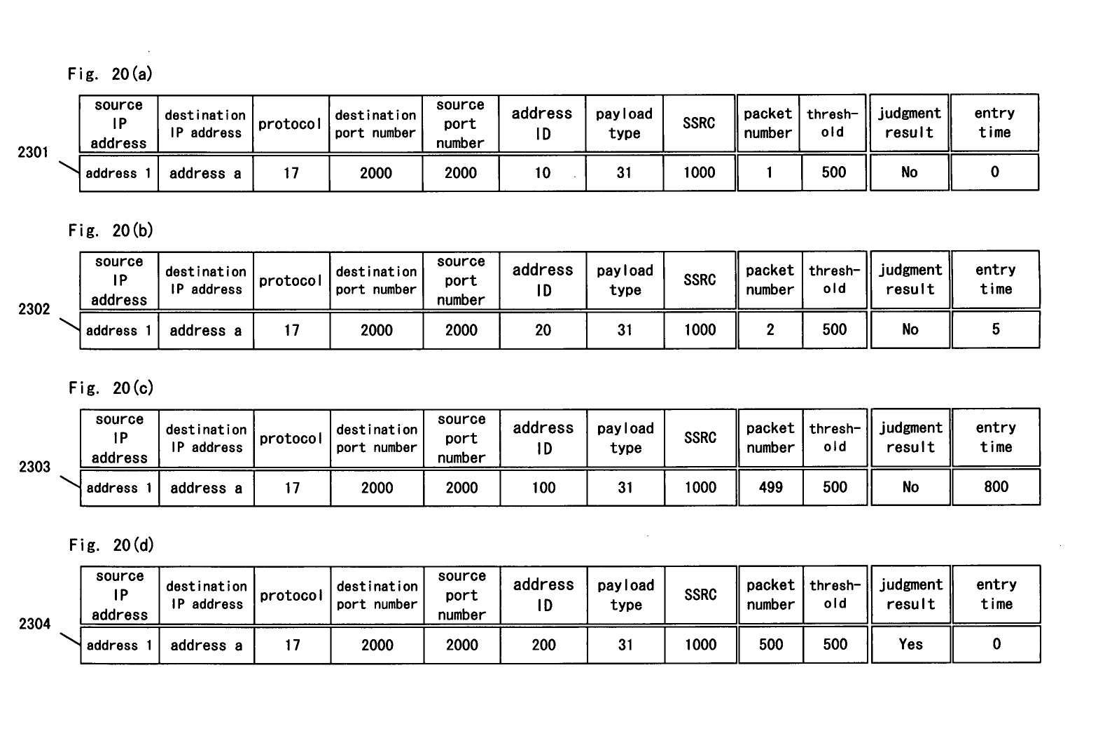

As shown in FIG. 20, every entry of the flow table 1903 has the following fields: a source IP address; a destination IP address; a protocol number; an identification; and a port number of a TCP/UDP header.

Furthermore, every entry of the flow table 1903 has the following fields: a number of packets that have reached to the outputting interface 1102n within predetermined time; an RTP threshold; a judgment result indicating whether or not being an RTP packet; and information indicating when this entry has registered into the flow table 1903.

In FIG. 19, an entry-judging unit 1901 judges whether or not an inputted packet is an object of an entry of the flow table 1903.

In this embodiment, the entry-judging unit 1901 judges that the inputted packet is the object when all of the following conditions are fulfilled: (1) a higher-level protocol of IP of the inputted packet is the UDP; (2) a port number is an even number that is “1024” or more; (3) a value of a bit string corresponding to a version field of an RTP header is “2”; and (4) a value of a bit string corresponding to a payload type field is not less than “0” and not greater than “34”, or, not less than “96” and not greater than “127”.

The flow table-registering unit 1902 registers information of a flow relating to the inputted IP packet into the flow table 1903. In this embodiment, an entry judged not related to a flow of RTP packets is also registered into the flow table 1903.

An RTP-judging unit 1904 judges that the inputted packet is an RTP packet, when a flow of the inputted packet has been registered in the flow table 1903 and further the inputted packet has reached continuously to the outputting interface 1102n for predetermined time.

When the RTP-judging unit 1904 judges that the inputted packet is an RTP packet and further that a flow relating to the inputted packet has not been registered in the flow table 1903, the flow table-registering unit 1902 registers a new entry relating to the flow to the flow table 1903. The new entry has a destination IP address, a source IP address, a protocol number, a destination port number, a source port number, and an identification, which are all equal to those of the inputted packet.

RTCP conditions, which are conditions for judging whether or not the inputted IP packet includes an RTCP packet, are as follows: (1) all of a source IP address, a destination IP address, and a protocol number are equal between the inputted IP packet and an IP packet being judged as an RTP packet; and (2) a value of a port number of the inputted IP packet decreased by a value of “1” is equal to a port number of the IP packet being judged as an RTP packet.

When an inputted IP packet is contradictory to contents of an entry of the flow table 1903, an RTP entry-deleting unit 1906 deletes this entry from the flow table 1903. In this embodiment, concerning an entry being registered in the flow table 1903, when it is found that a value of a bit string corresponding to a payload type field is not equal to a value of a bit string of an SSRC field, it is judged that the inputted IP packet is contradictory to the contents of the entry.

The RTP entry-deleting unit 1906 corresponds to an item-deleting unit that deletes information of a flow from the flow table 1903, when a packet belonging to a flow defined in the flow table 1903 is inputted and a value of a bit string corresponding to a payload type field is not equal to a value of a bit string of an SSRC field.

Referring to a judgment result by the RTP-judging unit 1904 and the packet-classifying-rule-storing unit 107, the packet-classifying unit 103 outputs the inputted IP packet into a queue of a corresponding class.

FIG. 20(a) to FIG. 20(g) show contents of the flow table 1903 at a certain time. A unit of entry time is a millisecond. In this embodiment, for judging whether or not inputted IP packets continue, the following AV thresholds are used. An AV threshold for audio packets is 30 pieces per second. And, an AV threshold for video packets is 500 pieces per second.

It is assumed that a rule of “RTP data should be processed with high priority” and a rule of “RTCP data should be processed with high priority” are defined in the packet-classifying-rule-storing unit 107 as shown in FIG. 22(b).

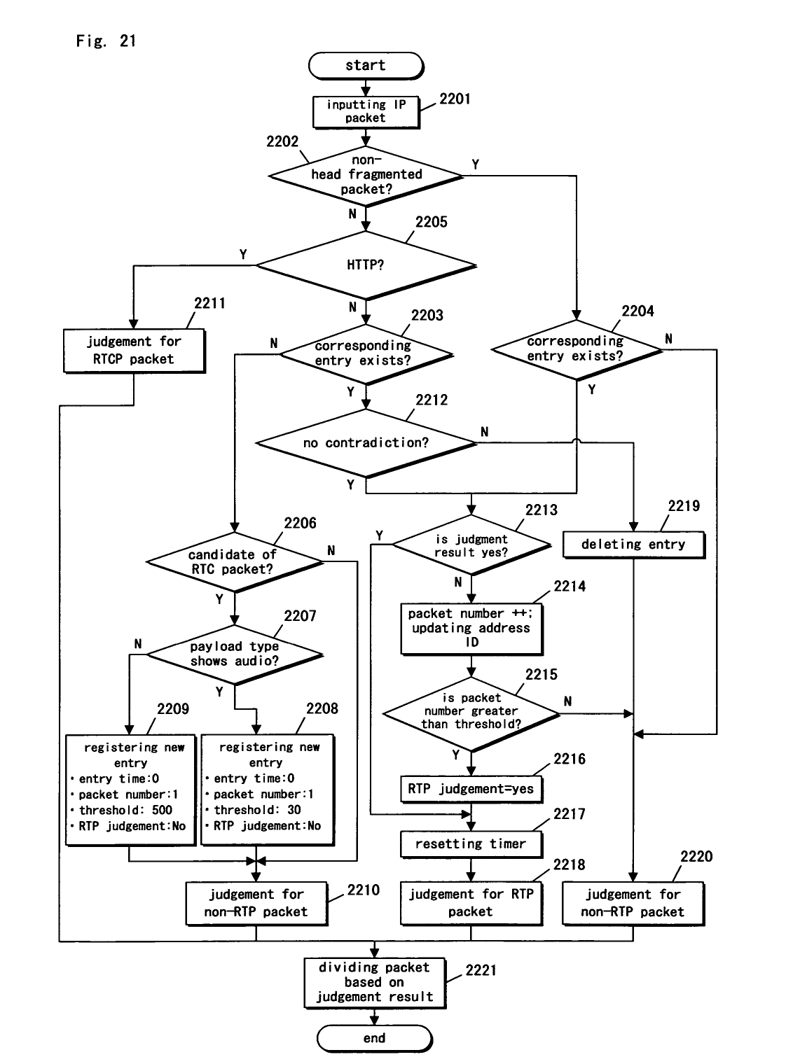

FIG. 21 is a flow chart of an outputting interface 1102n in the embodiment 5 of the present invention. Hereafter, processes in this embodiment will be explained illustrating some cases.

(Case 1): The flow table 1903 is empty; an IP packet is inputted into the outputting interface 1102n; the inputted packet is not a non-head fragmented packet; and the inputted packet includes a UDP packet (steps 2201 and 2202)

At step 2205 of FIG. 21, since there is no entry in the flow table 1903 at this time and there is no IP packet judged to include an RTP packet, the inputted packet does not correspond to the RTCP conditions.

At step 2203, in the flow table 1903, there is no entry whose source IP address, destination IP address, protocol number, source port number, and destination port number are all equal to those of the inputted IP packet. Therefore, the entry-judging unit 1901 judges whether or not the inputted IP packet is a candidate of an IP packet including an RTP packet (step 2206).

To be more specific, the entry-judging unit 1901 performs the same processes as steps 601, 602, and 603 of FIG. 10, and judges that an IP packet is an IP packet including an RTP packet, when the inputted IP packet fulfills the conditions for including an RTP packet, that is, all the conditions of steps 601, 602, and 603.

When the inputted IP packet fulfills the conditions for including an RTP packet and further a value of a bit string corresponding to a payload type field is a value of “31”, at step 2209, an entry relating to the inputted IP packet is registered into the flow table 1903 as a candidate of a video packet as shown in FIG. 20(a). Furthermore, it is judged that the inputted IP packet does not include an RTP packet (step 2210), and the packet-classifying unit 1905 outputs the inputted IP packet into the queue 109 (step 2221). Note that, when a value of a bit string corresponding to a payload type field is a value of “31”, an RTP packet contains data encoded according to the video compression format H.261 advised by the ITU-T in the payload thereof.

(Case 2): The flow table 1903 is in a state of FIG. 20(a); an IP packet is inputted into the outputting interface 1102n; the inputted packet is not a non-head fragmented packet (step 2202); and the inputted packet corresponds to the entry 2301. That is, all of a source IP address; a destination IP address; a protocol number; a source port number; and a destination port number of the entry 2301 are included in an IP header of the inputted IP packet.

Also in this case, at step 2205 of FIG. 21, since there is no entry in the flow table 1903 at this time and there is no IP packet judged that includes an RTP packet, the inputted packet does not correspond to the RTCP conditions. Therefore, the RTP packet judging unit 1904 checks whether or not an entry relating to the inputted IP packet has been registered in the flow table 1903 (step 2203).

At step 2203, the RTP-judging unit 1904 checks whether or not there is an entry whose source IP address, destination IP address, protocol number, source port number, and destination port number are all equal to those of the inputted IP packet. In this case, in step 2203, the inputted IP packet corresponds to an entry 2301.

At step 2212, since a value of a bit string corresponding to a payload type field of an RTP header is a value of “31” and a value of a bit string of an SSRC field is a value of “1000 ”, the inputted IP packet is not contradictory to the conditions for a candidate including an RTP packet (step 2212). Therefore, processes move to step 2213.

Since a judgment result of whether or not the inputted IP packet includes an RTP packet is “No” at this time (step 2213), a value of “1” is added to the packet number of the entry 2301 (step 2214). However, after addition, since the packet number is less than an RTP-judging threshold of “500” (step 2215), the inputted IP packet is judged to be not an RTP packet (step 2220). These processes change the entry 2301 to an entry 2302 of FIG. 20 (b).

When contradiction of an entry is found at step 2212, the RTP item-deleting unit 1906 deletes the entry from the flow table 1903 (step 2219), and it is judged that the inputted IP packet does not include an RTP packet (step 2220).

(Case 3): The flow table 1903 is in a state of FIG. 20(a); an IP packet is inputted into the outputting interface 1102n; the inputted packet is not a non-head fragmented packet (step 2202); and the inputted packet corresponds to the entry 2303. That is, all of a source IP address; a destination IP address; a protocol number; a source port number; and a destination port number of the entry 2303 are included in an IP header of the inputted IP packet.

In this case, at step 2203, the inputted IP packet corresponds to an entry 2303.

At step 2212, since a value of a bit string corresponding to a payload type field of an RTP header is a value of “31” and a value of a bit string of an SSRC field is a value of “1000”, the inputted IP packet is not contradictory to the conditions for a candidate including an RTP packet (step 2212). Therefore, processes move to step 2213 and 2214.

Since the packet number becomes a value of “500”, it is judged that the inputted IP packet includes an RTP packet (steps 2216, 2217, and 2218). These processes change the entry 2303 to an entry 2304 of FIG. 20(d).

(Case 4): The flow table 1903 is in a state of FIG. 20(d); an IP packet is inputted into the outputting interface 1102n; the inputted packet is not a non-head fragmented packet (step 2202); and the inputted packet corresponds to the entry 2304. That is, all of a source IP address; a destination IP address; a protocol number; a source port number; and a destination port number of the entry 2304 are included in the IP header of the inputted IP packet.

In this case, the entry 2304 judged to be related to an RTP packet exists in the flow table 1903, and at step 2205 of FIG. 21, this entry 2304 corresponds to the RTCP conditions for the inputted IP packet. Therefore, it is judged that the inputted IP packet includes an RTCP packet (step 2211), and the packet-classifying unit 1905 outputs the inputted IP packet into the queue 108 (step 2221).

In this embodiment, similar to the embodiment 4, when a non-head fragmented packet is inputted (step 2202), the RTP-judging unit 1904 searches the flow table 1903 for an entry whose source IP address, destination IP address, protocol number, and identification are all equal to those of the inputted IP packet (step 2204). When the entry exists, the RTP-judging unit 1904 updates contents of the entry and judges whether or not the entry relates to an RTP packet (steps 2214 and 2215). When the entry does not exist, the RTP-judging unit 1904 judges that the inputted IP packet does not include an RTP packet (step 2220).

### Embodiment 6

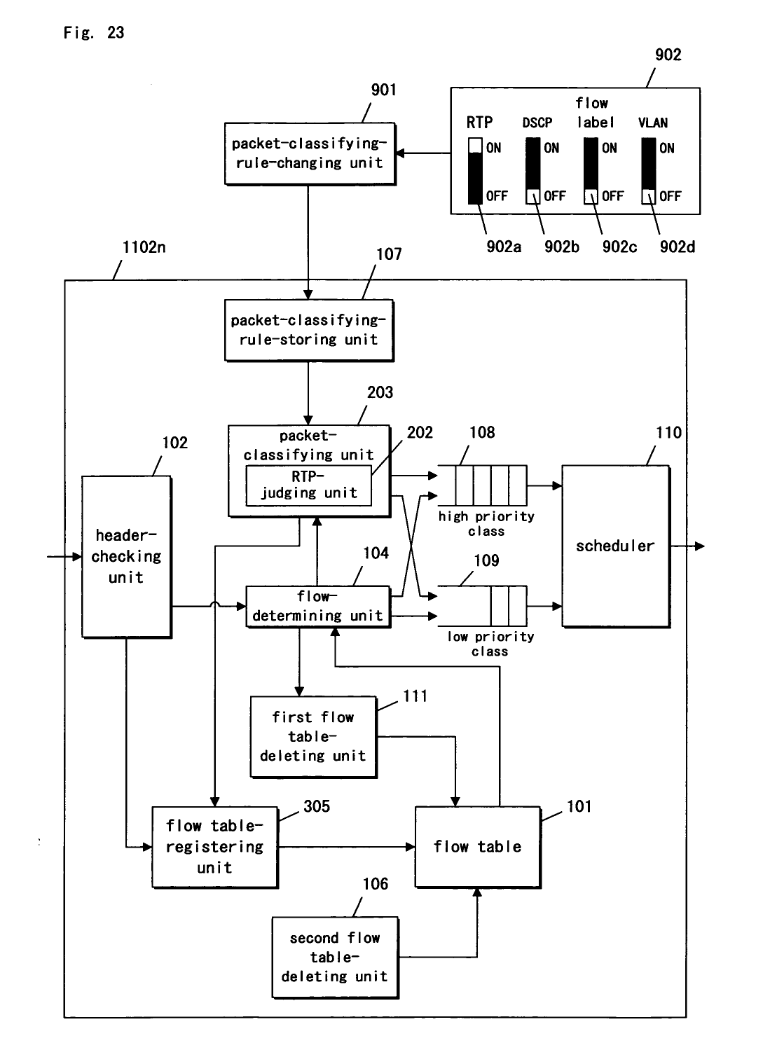

Referring to FIG. 23 to FIG. 25, an embodiment 6 of the present invention will now be explained. This embodiment corresponds to changing packet-classifying-rules.

FIG. 23 is a block diagram of an outputting interface 1102n in the embodiment 6 of the present invention. In this embodiment, a packet-classifying-rule-changing unit 901 and a switch 902 are added to construction of the embodiment 3 shown in FIG. 11. Of course, a packet-classifying-rule-changing unit 901 and a switch 902 may be added to any of a plurality of kinds of construction of the embodiments 1, 2, 4 and 5.

As shown in FIG. 23, the packet-relaying device 1100 comprises the switch 902 that sets rules for classifying IP packets. Due to this, it is easy for a user of an ordinary home to process a specific flow preferentially.

The switch 902 comprises the following elements: an RTP switch 902a for determining a class to which an application using an RTP should be classified; a DSCP switch 902b for changing whether or not processes corresponding to a value of DSCP are enabled; a flow label switch 902c for changing whether or not processes corresponding to a flow label of an IPv6 packet are enabled; and a VLAN tag switch 902d for changing whether or not processes corresponding to priority of a frame with a VLAN tag are enabled.

The packet-classifying-rule-changing unit 901 changes contents of the packet-classifying-rule-storing unit 107 according to a change of the switch 902.

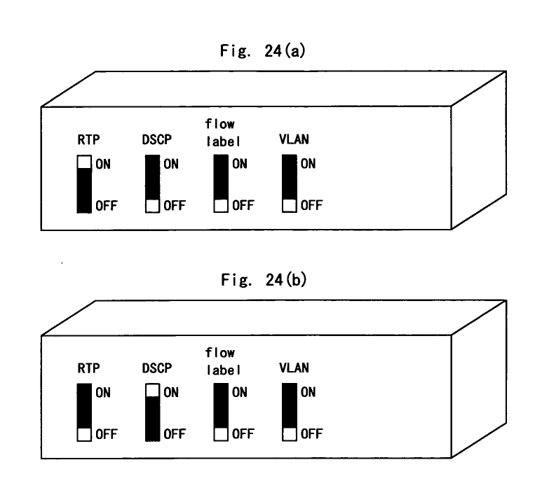

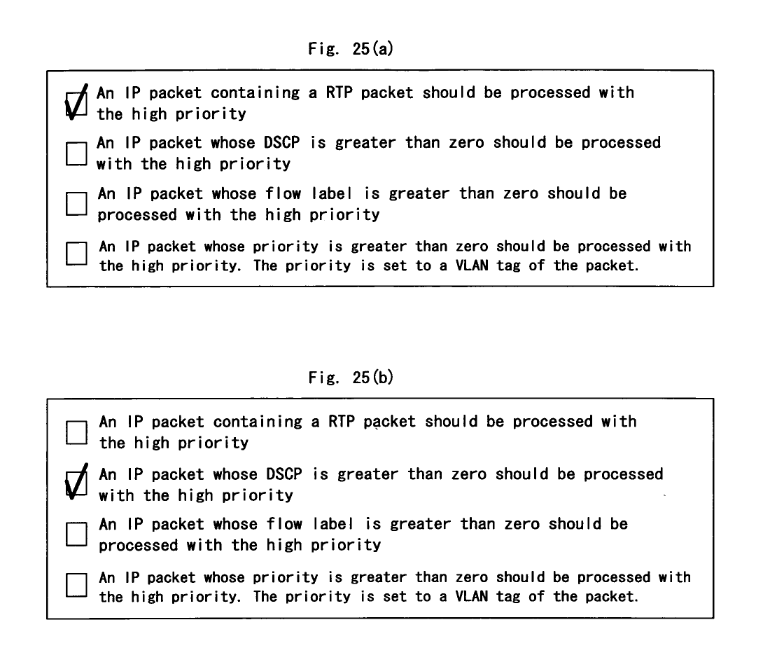

FIG. 24(a) and FIG. 24(b) show appearance of the outputting interface 1102n and states of the switch 902. Herein, the outputting interface 1102n comprises the switch 902 as a user interface for setting rules for classifying IP packets. Each of FIG. 25(a) and FIG. 25(b) shows an example of a rule that is changed by the switch 902 and stored in the packet-classifying-rule-storing unit 107.

In this example, class specification by the RTP switch 902a can be done within 2 levels, that is, a high priority class and a low priority class. When the RTP switch is turned “ON”, RTP packets are processed as a high priority class. When the RTP switch is turned “OFF”, RTP packets are processed as a low priority class.

When only the RTP switch 902a is “ON” (Enable), the packet-classifying-rule-changing unit 901 corrects the contents of the packet-classifying-rule-storing unit 107 according to the state of the switch 902.

FIG. 25(a) shows contents of the packet-classifying-rule-storing unit 107 in the state of the switch 902 as shown in FIG. 23. In the state of FIG. 23, the outputting interface 1102n performs the same processes of the embodiment 3 to an inputted IP packet.

When only the DSCP switch 902b is “ON” (Enable), the packet-classifying-rule-changing unit 901 corrects the contents of the packet-classifying-rule-storing unit 107 according to the state of the switch 902.

FIG. 25(b) shows contents of the packet-classifying-rule-storing unit 107 in the state of the switch 902 as shown in FIG. 24(b). In the state of FIG. 24(b), the outputting interface 1102n classifies and performs an inputted IP packet whose DSCP is “0” as a low priority class and classifies and performs an inputted IP packet whose DSCP is “1” or more as a high priority class.

As described above, when only the flow label switch 902c is “ON” (Enable), the outputting interface 1102n classifies and performs an inputted IP packet whose flow label of an IPv6 packet is “0” as a low priority class and classifies and performs an inputted IP packet whose flow label of an IPv6 packet is “1” or more as a high priority class.

Similarly, when only the VLAN tag switch 902d is “ON” (Enable), the outputting interface 1102n classifies and performs an inputted IP packet whose priority of a frame with a VLAN tag is “0” as a low priority class and classifies and performs an inputted IP packet whose priority of a frame with a VLAN tag is “1” or more as a high priority class.

In all embodiments of the present invention, priority of an IP packet has two levels. However, the present invention can apply to cases where three or more levels of priority of an IP packet exist, when the flow table and a plurality of queues are provided according to the number of the levels.

In every entry of the flow tables 101, 1803 and 1903, class information is added. However, when priority for classifying IP packets has two levels, adding class information can be omitted. For example, an entry of an IP packet of a high priority class is registered into a flow table, and when there is an entry relating to an inputted IP packet, the inputted IP packet is processed as an IP packet of the high priority class.

A level for an IP packet including an RTP packet may be allocated to one of the three or more levels of priority of an IP packet.

After the second flow table-deleting unit 106 has completed checking all entries of a flow table, an intermission in processes of the second flow table-deleting unit 106 may be provided. Otherwise, the intermission may not be provided.

When the plurality of switches 902a, 902b, 902c and 902d are “ON” (Enable), any of the followings may be done: (1) estimating an AND of rules for which the corresponding switches are “ON” (Enable); (2) estimating an OR of rules for which the corresponding switches are “ON” (Enable); (3) providing each of the switches with priority and reflecting to the packet-classifying rule only one rule whose switch has the highest priority among the switches being “ON”, while the other rules are considered to be invalid.

Each entry of the flow tables 1803 and 1903 has fields for, a packet number indicating how many packets are inputted for predetermined time, an AV/RTP threshold, judgment result whether or not being an AV/RTP packet, and entry time. However, information of the fields may be stored in one or more tables different from the flow tables 1803 and 1903.

Furthermore, of course, the embodiments 4 and 5 of the present invention are mere examples. In short, whether an inputted IP packet is an AV packet or whether an inputted IP packet includes an RTP packet, may be determined based on a judgment result indicating whether or not the a certain number of IP packets reach to the packet-relaying device for predetermined time.

According to the present invention, a countermeasure against cases where fragmentation occurs, and a countermeasure against RTP/RTCP packets, which are difficult with the conventional techniques, can be taken without complicated setting. And, users of the packet-relaying device can set up the packet-classifying rule easily.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A packet-relaying device, comprising:
a plurality of queues, each of said plurality of queues being operable to store a packet in correspondence to priority thereof;
a scheduler operable to take out a packet from one of said plurality of queues to output the packet to outside of the packet-relaying device;
a packet-classifying-rule-storing unit operable to store a packet-classifying rule;
a packet-classifying unit operable to output a packet to one of said plurality of queues based on the packet-classifying rule stored in said packet-classifying-rule-storing unit; and
a flow information-storing unit operable to store flow-defining information of a flow and priority information of the flow,
wherein said flow information-storing unit is operated in a manner different from that of said packet-classifying-rule-storing unit.

2. A packet-relaying device as defined in claim 1, wherein the flow-defining information includes a source IP address of an IP header, a destination IP address of the IP header, a protocol number of the IP header, and an identification of the IP header.

3. A packet-relaying device as defined in claim 1, further comprising a header-checking unit operable to check whether or not an inputted packet is a non-head fragmented packet.

4. A packet-relaying device as defined in claim 3, wherein said header-checking unit is operable to judge whether or not the inputted packet is a head fragmented packet, and
wherein the packet-relaying device further comprises a flow information-registering unit operable to register, into said flow information-storing unit, flow-defining information of a flow to which the inputted packet belongs and priority information of the flow when said header-checking unit judges that the inputted packet is a head fragmented packet.

5. A packet-relaying device as defined in claim 3, further comprising a flow-determining unit operable to output a packet that is judged to be a non-head fragmented packet by said header-checking unit to one of said plurality of queues, based on the flow-defining information and the priority information stored in said flow information-storing unit,
wherein said packet-classifying unit outputs a packet that is judged to be not a non-head fragmented packet by said header-checking unit to one of said plurality of queues, based on the packet-classifying rule stored in said packet-classifying-rule-storing unit.

6. A packet-relaying device as defined in claim 5, wherein said flow-determining unit judges whether a non-head fragmented packet is a final non-head fragmented packet, and
wherein the packet-relaying device further comprises a deleting unit operable to delete flow-defining information of a flow to which the final non-head fragmented packet belongs and priority information of the flow from said flow information-storing unit.

7. A packet-relaying device as defined in claim 1, further comprising a deleting unit operable to delete flow-defining information of a flow when any packet belonging to the flow is not inputted for a predetermined time and priority information of the flow from said flow information-storing unit.

8. A packet-relaying device as defined in claim 1, further comprising a flow-determining unit operable to output a packet to one of said plurality of queues based on flow-defining information and priority information stored in said flow information-storing unit when the flow-defining information of a flow of the packet and the priority information of the flow are registered in said flow information-storing unit,
wherein said packet-classifying unit outputs the packet to one of said plurality of queues based on packet-classifying rule stored in said packet-classifying-rule-storing unit when the flow-defining information of a flow of the packet and the priority information of the flow are not registered in said flow information-storing unit.

9. A packet-relaying device as defined in claim 8, further comprising an RTP-judging unit operable to judge whether or not the packet is an RTP packet.

10. A packet-relaying device as defined in claim 9, wherein, when the packet has a UDP header, and a port number of the UDP header is an even number that is “1024” or more, said RTP-judging unit judges that the packet is an RTP packet, according to at least one of a version field after the UDP header and a payload type field of an RTP payload, the version field indicating an RTP protocol version.

11. A packet-relaying device as defined in claim 9, further comprising a flow information-registering unit operable to register, when said RTP-judging unit judges that the packet is an RTP packet, flow-defining information of a flow of the packet and priority information of the flow into said flow information-storing unit.

12. A packet-relaying device as defined in claim 9, wherein the flow-defining information includes a port number of a TCP/UDP header, and
wherein, when said RTP-judging unit judges that the packet is an RTP packet, said flow-determining unit outputs the packet to one of said plurality of queues, based on information that a value of “1” is added to a port number of a TCP/UDP header of flow-defining information relating to the packet and priority information of an RTCP packet.

13. A packet-relaying device as defined in claim 9, wherein the flow-defining information includes a port number of a TCP/UDP header, and
wherein, when said RTP-judging unit judges that the packet is an RTP packet, said flow information-registering unit registers information that a value of “1” is added to a port number of a TCP/UDP header of flow-defining information relating to the packet and priority information of the packet into said flow information-storing unit.

14. A packet-relaying device as defined in claim 9, further comprising a header-checking unit operable to judge if an inputted packet is a non-head fragmented packet,
wherein said flow-determining unit inputs the inputted packet from said header-checking unit.

15. A packet-relaying device as defined in claim 1, further comprising an AV packet-judging unit operable to judge whether or not an inputted packet is an AV packet,
wherein said packet-classifying unit outputs the packet to one of said plurality of queues such that an AV packet has higher priority than a non AV packet.

16. A packet-relaying device as defined in claim 15, wherein, when the inputted packet is an HTTP packet, said AV packet-judging unit judges whether or not the inputted packet is an AV packet according to information of Context-Type of the inputted packet.

17. A packet-relaying device as defined in claim 15, wherein, when a packet of a flow defined in said flow information-storing unit has been inputted continuously for a predetermined time, said AV packet-judging unit judges that the flow defined in said flow information-storing unit is a flow of an AV packet.

18. A packet-relaying device as defined in claim 15, wherein said AV packet-judging unit judges whether or not a flow defined in said flow information-storing unit is related to an AV packet, by comparing a number of inputted packets of the flow with a predetermined AV threshold.

19. A packet-relaying device as defined in claim 15, wherein said flow information-storing unit stores information of an AV threshold concerning a flow defined therein, and
wherein said AV packet-judging unit judges whether or not the packet is an AV packet using the AV threshold that is stored in said flow information storing unit and that is set based on packet size such that the AV threshold is greater for a video packet than for an audio packet.

20. A packet-relaying device as defined in claim 19, further comprising an item-deleting unit operable to delete information of a flow from said flow information-storing unit when an inputted packet defined in said flow information-storing unit has a packet size different from the packet size stored in said flow information-storing unit.

21. A packet-relaying device as defined in claim 1, further comprising an RTP-judging unit operable to judge whether or not an inputted packet is an RTP packet,
wherein said RTP-judging unit judges that a flow defined in said flow information-storing unit is a flow of an RTP packet when a packet of the flow defined in said flow information-storing unit has been inputted continuously for a predetermined time.

22. A packet-relaying device as defined in claim 21, wherein said RTP-judging unit judges whether or not a flow defined in said flow information-storing unit is related to an RTP packet, by comparing a number of inputted packets of the flow with a predetermined RTP threshold.

23. A packet-relaying device as defined in claim 21, wherein said flow information-storing unit stores information of an AV threshold of a flow defined therein, and
wherein said RTP-judging unit judges whether or not an inputted packet is an RTP packet by using the AV threshold that is stored in said flow information storing unit and that is set such that the AV threshold is greater for a video packet than for an audio packet.

24. A packet-relaying device as defined in claim 21, wherein said RTP-judging unit judges that information relates to a flow of an RTCP packet, the information including an item that a value of “1” is added to a port number of a TCP/UDP header of the flow-defining information regarded as relating to an RTP packet and stored in said flow information-storing unit.

25. A packet-relaying device as defined in claim 21, wherein said flow information-storing unit stores SSRC information of an RTP header.

26. A packet-relaying device as defined in claim 25, further comprising an item-deleting unit operable to delete information of a flow from said flow information-storing unit, in at least one of
a case where a packet belonging to a flow defined in said flow information-storing unit is inputted and SSRC information to which the inputted packet belongs is not equal to a value of a SSRC field of an RTP header of the inputted packet, and
a case where a packet belonging to a flow defined in said flow information-storing unit is inputted and a value of a payload type field to which the inputted packet belongs is not equal to a value of a payload type field of an RTP header of the inputted packet.

27. A packet-relaying device as defined in claim 1, further comprising:
a switch and
a packet-classifying-rule-changing unit operable to change the packet-classifying rule stored in said packet-classifying-rule-storing unit according to a state of said switch.

28. A packet-relaying device as defined in claim 27, wherein said switch comprises at least one of
an RTP switch operable to specify a class to which an application using an RTP should be classified; a DSCP switch operable to enable or disenable processes corresponding to a value of DSCP; a flow label switch operable to enable or disenable processes corresponding to a flow label of an IPv6 packet; and a VLAN tag switch operable to enable or disenable processes corresponding to priority of a frame with a VLAN tag.
